(19) United States
(12) Patent Application Publication
(10) Pub. No.: US 2025/0351205 A1
(43) Pub. Date: Nov. 13, 2025

(54) Wireless Audio Data Transmission Method and Related Devices

(71) Applicant: Zhejiang Zgmicro Company Limited, Shaoxing (CN)

(72) Inventor: Bin Xu, Shaoxing (CN)

(73) Assignee: Zhejiang Zgmicro Company Limited, Shaoxing (CN)

(21) Appl. No.: 19/204,757

(22) Filed: May 12, 2025

(30) Foreign Application Priority Data
May 13, 2024 (CN) 2024105913310
May 22, 2024 (CN) 2024106370773

(51) Int. Cl. H04W 76/10; G06F 3/16

(52) U.S. Cl. CPC H04W 76/10; G06F 3/162

(57) ABSTRACT

The present disclosure provides a wireless audio data transmission method and related devices. The method is applied to a transmitting device group comprising a master transmitting device and one or more slave transmitting devices synchronized with the master transmitting device. The method comprises: transmitting a first broadcast packet to one or more receiving devices based on a first communication link group by the master transmitting device, and/or transmitting a second broadcast packet to the one or more receiving devices based on a second communication link group by at least one of the one or more slave transmitting devices within one of multiple continuous isochronous intervals; wherein the first broadcast data packet and the second broadcast data packet that correspond to each other are generated based on the same audio frame in an audio stream, and carry the same audio data. The present disclosure improves reliability of audio stream transmission.

### CROSS-REFERENCE TO RELATED APPLICATIONS

This application claims priorities benefit to Chinese Patent Application No. 2024105913310 filed on May 13, 2024, and to Chinese Patent Application No. 2024106370773 filed on May 22, 2024, the entire contents of which are incorporated herein by reference.

### TECHNICAL FIELD

The present disclosure relates to the technical field of wireless audio, and in particular, to a wireless audio data transmission method, a wireless audio data transmission device and a wireless audio data transmission system.

### BACKGROUND

Bluetooth Low Energy (BLE) audio technology employs Isochronous Channels protocol, comprising a Connected Isochronous Stream (CIS) link for point-to-point communication and a Connected Isochronous Group (CIG) link composed of at least one CIS link, as well as a Broadcast Isochronous Stream (BIS) link for point-to-multipoint communication and a Broadcast Isochronous Group (BIG) link composed of at least one BIS link. It can provide users with lower power consumption, lower cost, lower delay, higher quality and more diverse wireless audio services. For example, it can achieve a point-to-multipoint Wireless Broadcast Audio (WBA) function through the BIG link.

However, when the WBA function based on the BIG link is used in public places such as an airport, a station, a banquet hall, or a coffee shop, it is difficult to cover an entire area with a single transmitting device. Therefore, a WBA receiving device in some distant or obstructed areas may experience degraded reception performance that fails to meet user requirements.

### SUMMARY

The purpose of the present disclosure is to provide a wireless audio data transmission method, a wireless audio data transmission device and a wireless audio data transmission system, which are used to solve a technical problem of poor transmission reliability existing in conventional technologies when using a WBA function based on BIG links.

To achieve the purpose, according to one aspect of the present disclosure, a wireless audio data transmission method applied to a transmitting device group comprising a master transmitting device and one or more slave transmitting devices synchronized with the master transmitting device is provided. The method comprises: transmitting, by the master transmitting device, a first broadcast packet to one or more receiving devices based on a first communication link group, and/or transmitting, by at least one of the one or more slave transmitting devices, a second broadcast packet to the one or more receiving devices based on a corresponding second communication link group within one of multiple continuous isochronous intervals. The first broadcast data packet and the second broadcast data packet that correspond to each other are generated based on the same audio frame in an audio stream to be transmitted, and the first broadcast data packet and the second broadcast data packet generated based on the same audio frame carry the same audio data.

According to another aspect of the present disclosure, a wireless audio data transmission method applied to a master transmitting device is provided. The method comprises: transmitting a joint auxiliary synchronization data packet to one or more receiving devices via a second advertising channel so that the one or more receiving devices can synchronize with the master transmitting device, receive a first broadcast data packet transmitted by the master transmitting device via a first communication link group, and/or receive a second broadcast data packet transmitted by corresponding slave transmitting device via at least one second communication link group when the master transmitting device is clock-synchronized with one or more slave transmitting devices; wherein the first broadcast data packet and the second broadcast data packet that correspond to each other are generated based on the same audio frame in an audio stream to be transmitted, and the first broadcast data packet and the second broadcast data packet generated based on the same audio frame carry the same audio data.

According to another aspect of the present disclosure, a wireless audio data transmission method applied to a candidate transmitting device is provided. The method comprises: jointing with a master transmitting device via a bidirectional periodic advertising link and establishing a second communication link group for communication with one or more receiving devices, wherein the master transmitting device is configured to transmits a first broadcast data packet to the one or more receiving devices via a first communication link group; transmitting a second broadcast data packet to the one or more receiving devices via the second communication link group; wherein the first broadcast data packet and the second broadcast data packet that correspond to each other are generated based on the same audio frame in an audio stream to be transmitted, and the first broadcast data packet and the second broadcast data packet generated based on the same audio frame carry the same audio data.

According to another aspect of the present disclosure, a wireless audio data transmission system is provided. The system comprises: a transmitting device group comprising a master transmitting device and one or more slave transmitting devices synchronized with the master transmitting device; and one or more receiving devices, wherein the master transmitting device transmits a first broadcast packet to the receiving devices based on a first communication link group, and/or at least one of the one or more slave transmitting devices transmits a second broadcast packet to the receiving devices based on a second communication link group within one of multiple continuous isochronous intervals; wherein the first broadcast data packet and the second broadcast data packet that correspond to each other are generated based on the same audio frame in an audio stream to be transmitted, and the first broadcast data packet and the second broadcast data packet generated based on the same audio frame carry the same audio data.

In the present disclosure, by coordinating multiple transmitting devices located at different spatial positions to broadcast the same audio data to the receiving devices from different directions and/or angles, the adverse effects of interference factors such as obstacles on audio transmission are reduced effectively, so that the receiving device located in a designated area can stably receive the audio data at an arbitrary spatial location, thereby improving reliability of the audio stream transmission, and consequently improving overall communication performance of the wireless audio data transmission system where the receiving devices are located.

There are many other objects, together with the foregoing attained in the exercise of the disclosure in the following description and resulting in the embodiment illustrated in the accompanying drawings.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic flow diagram of a wireless audio data transmission method provided according to one embodiment of the present disclosure;

FIG. 2 is a schematic diagram of a common extended advertising payload format provided according to one embodiment of the present disclosure;

FIG. 3 is a schematic diagram of an extended header format provided according to one embodiment of the present disclosure;

FIG. 4 is a schematic diagram of extended header flag bits provided according to one embodiment of the present disclosure;

FIG. 5 is a schematic flow diagram of a master transmitting device allowing a candidate transmitting device to access a JBIG link provided according to one embodiment of the present disclosure;

FIG. 6 is a schematic flow diagram of a candidate transmitting device establishing an ABIG link and accessing the JBIG link provided according to one embodiment of the present disclosure;

FIG. 7 is a schematic flow diagram of an operating process of a receiving device provided according to one embodiment of the present disclosure;

FIG. 8 is a schematic diagram of a slot structure provided according to one embodiment of the present disclosure;

FIG. 9 is a schematic diagram of another slot structure provided according to one embodiment of the present disclosure;

FIG. 10 is a schematic flow diagram of another wireless audio data transmission method provided according to one embodiment of the present disclosure;

FIG. 11 is a schematic flow diagram of yet another wireless audio data transmission method provided according to one embodiment of the present disclosure;

FIG. 12 is a schematic flow diagram of a wireless audio data transmission method corresponding to a receiving device provided according to one embodiment of the present disclosure;

FIG. 13 is a schematic structural diagram of a wireless audio data transmission system provided according to one embodiment of the present disclosure;

FIG. 14 is a schematic structural diagram of a wireless audio data transmission device provided according to one embodiment of the present disclosure;

FIG. 15 is a schematic structural diagram of another wireless audio data transmission device provided according to one embodiment of the present disclosure;

FIG. 16 is a schematic structural diagram of a wireless audio data transmission device corresponding to the receiving device provided according to one embodiment of the present disclosure;

FIG. 17 is a schematic structural diagram of a wireless audio data transmission device provided according to one embodiment of the present disclosure; and

FIG. 18 is a schematic structural diagram of an electronic device provided according to one embodiment of the present disclosure.

### DETAILED DESCRIPTION

The detailed description of the disclosure is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

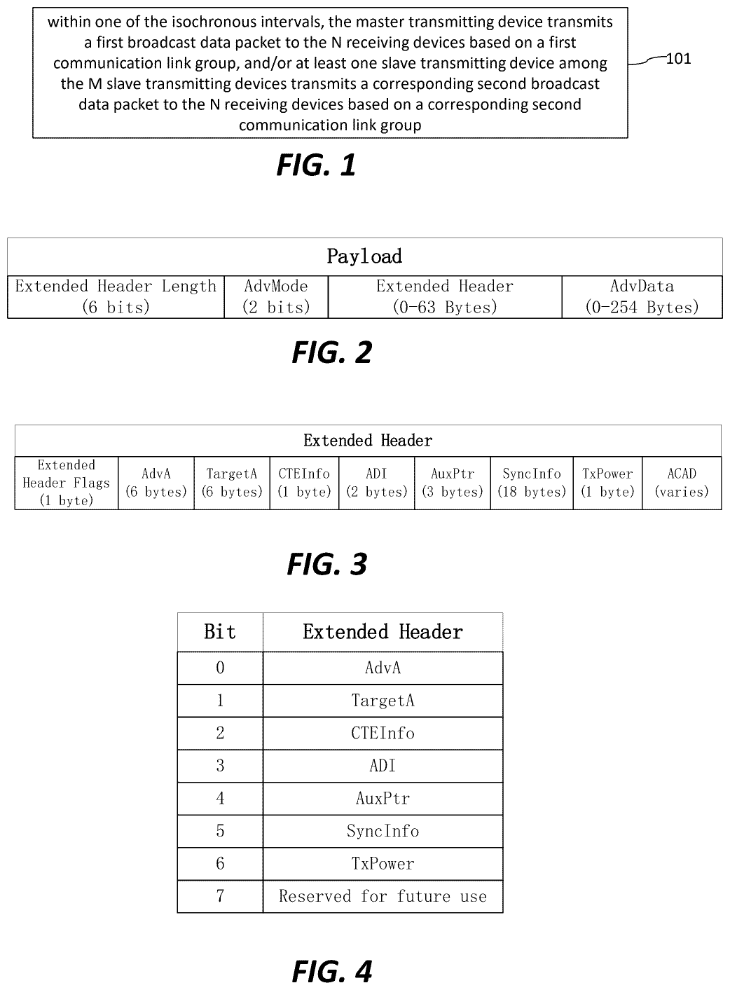

A wireless audio data transmission method applied to a transmitting device group is provided according to one embodiment of the present disclosure. The transmitting device group comprises a master transmitting device and M slave transmitting devices synchronized with the master transmitting device in clock. The transmitting devices in the transmitting device group perform broadcast communication with N receiving devices within continuous isochronous intervals to transmit an audio stream, wherein N and M are positive integers. As shown in FIG. 1, the wireless audio data transmission method comprises: within one of the continuous isochronous intervals, the master transmitting device transmits a first broadcast data packet to the N receiving devices based on a first communication link group, and/or at least one slave transmitting device among the M slave transmitting devices transmits a corresponding second broadcast data packet to the N receiving devices based on a corresponding second communication link group at 101.

Within the continuous isochronous intervals, the first broadcast data packet generated based on a target audio frame is a target first broadcast data packet, and the second broadcast data packet corresponding to one target slave transmitting device generated based on the target audio frame is a target second broadcast data packet. The target audio frame is any audio frame in the audio stream, the target slave transmitting device is any slave transmitting device among the M slave transmitting devices, and audio data carried in the target first broadcast data packet is the same as that carried in the target second broadcast data packet.

In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

It should be understood that the transmitting device group corresponds to a set broadcast area, which can be adaptively determined according to actual scene requirements. For example, the set broadcast area may be an airport area, a station area, a banquet hall area, or a café area.

The multiple transmitting devices in the transmitting device group are located at different spatial positions, and their audio broadcast areas form a mixed broadcast area, with the set broadcast area located within the mixed broadcast area. For instance, the multiple transmitting devices in the transmitting device group may be arranged in an array within the set broadcast area.

Based on the above configuration, by coordinating multiple transmitting devices located at different spatial positions to broadcast the same audio data to the receiving devices from different directions and/or angles, the receiving devices within the set broadcast area can always find at least one ideal transmitting device for audio data reception. The “ideal transmitting device” can be understood as one transmitting device whose straight-line distance from the receiving device is less than or equal to a preset distance threshold, and whose audio interference on corresponding audio transmission path is less than or equal to a preset interference threshold.

Therefore, the adverse effects of interference factors such as obstacles on audio transmission are reduced effectively, so that the receiving device located in the set broadcast area can stably receive the audio data at an arbitrary spatial location, thereby improving reliability of the audio stream transmission, and consequently improving overall communication performance of the wireless audio data transmission system where the receiving devices are located.

The first broadcast data packet is obtained by processing the audio frame in the audio stream based on predefined encapsulation parameter information, and the second broadcast data packet is also obtained by processing the audio frame in the audio stream based on the same predefined encapsulation parameter information. By using the same parameter information (i.e., the predefined encapsulation parameter information) for audio frame processing, it is ensured that the first broadcast data packet and second broadcast data packet obtained based on the same audio frame carry the same audio data.

Exemplarily, the predefined encapsulation parameter information may comprise a parameter indicating a sampling rate, a parameter indicating a bit depth, a parameter indicating an encoding rate, and a parameter indicating an encoding method.

In one embodiment, among the first broadcast data packet and/or at least one second broadcast data packet transmitted within the same isochronous interval, any two different broadcast data packets occupy non-overlapping time slots and/or non-overlapping frequency domain channels.

This configuration avoids transmission conflicts between different broadcast data packets transmitted in the same isochronous interval.

The first broadcast data packet and/or at least one second broadcast data packet transmitted in the same isochronous interval may comprise the first broadcast data packet and at least one second broadcast data packet, or at least two second broadcast data packets.

In some embodiments, in any isochronous interval of the continuous isochronous intervals, the master transmitting device transmits the first broadcast data packet to the N receiving devices based on the first communication link group, and each slave transmitting device among the M slave transmitting devices transmits the corresponding second broadcast data packet to the N receiving devices based on the corresponding second communication link group, to maximize reliability of audio stream transmission.

In some embodiments, the master transmitting device transmits the first broadcast data packet in each isochronous interval of the continuous isochronous intervals, and at least one slave transmitting device transmits the corresponding second broadcast data packet in part of the isochronous intervals (e.g., the slave transmitting device transmits the corresponding second broadcast data packet every other isochronous interval). In this case, within one isochronous interval of the continuous isochronous intervals, the master transmitting device transmits the first broadcast data packet to the N receiving devices based on the first communication link group, and part of the slave transmitting devices among the M slave transmitting devices transmit the corresponding second broadcast data packets to the N receiving devices based on the corresponding second communication link groups. This ensures the reliability of audio stream transmission while reducing audio transmission energy consumption of the slave transmitting devices.

In some embodiments, both the master and slave transmitting devices transmit the first broadcast data packet and the second broadcast packet in each isochronous interval of the continuous isochronous intervals, but the time slots corresponding to the first broadcast data packet and the second broadcast data packet formed based on the same audio frame are be set to be located at different isochronous intervals. This extends a time span of the broadcast data packet corresponding to the audio frame during transmission, reduces the adverse effects of interference such as bandwidth fluctuations, and further improves the reliability of audio stream transmission.

In one embodiment, the method further comprises following operations:

The master transmitting device transmits a synchronized joint access data packet based on a first advertising channel and receives a synchronized joint request data packet fed back by a candidate transmitting device in response to the synchronized joint access data packet. The synchronized joint request data packet carries request link information, which comprises a device address and/or a device identifier of the candidate transmitting device.

When the master transmitting device determines that the candidate transmitting device is permitted to join the transmitting device group based on the device address and/or the device identifier, it transmits a synchronized joint configuration data packet to the candidate transmitting device. The synchronized joint configuration data packet carries configuration link information.

The master transmitting device receives a synchronized joint response data packet fed back by the candidate transmitting device in response to the synchronized joint configuration data packet, and designates the candidate transmitting device as one slave transmitting device. The candidate transmitting device establishes a corresponding second communication link group according to the configuration link information.

Further, the method further comprises following operations:

The master transmitting device transmits a joint auxiliary synchronization data packet based on a second advertising channel. The joint auxiliary synchronization data packet comprises central link information of the first communication link group and M auxiliary link information of the M second communication link groups. The joint auxiliary synchronization data packet is used for the receiving devices to synchronize with the master transmitting device, receive the first broadcast data packet based on the first communication link group, and receive corresponding second broadcast data packets based on the M second communication link groups, respectively.

By defining the synchronized joint access data packet, the synchronized joint request data packet, the synchronized joint configuration data packet, and the synchronized joint response data packet, and configuring transmission and reception processes of the corresponding packet, an identity conversion from the candidate transmitting device to the slave transmitting device is achieved to complete the operation of adding the candidate transmitting device into the transmitting device group.

It should be understood that the second communication link group established by any slave transmitting device in the transmitting device group is set by the master transmitting device based on the corresponding synchronized joint configuration data packet. In other words, multiple communication link groups corresponding to the transmitting device group (comprising the first communication link group and the M second communication link groups) are uniformly configured and managed by the master transmitting device. In this way, the synchronization between the M slave transmitting devices and the master transmitting device can be realized, thereby ensuring that within the same isochronous interval, different broadcast data packets transmitted based on different communication link groups occupy non-overlapping time slots, or the frequency domain channels occupied by the different broadcast data packets are non-overlapping when the time slots occupied by different broadcast data packets transmitted based on different communication link groups overlap.

By defining the joint auxiliary synchronization data packet and configuring the transmission process of the corresponding packet, different communication link information of different transmitting devices in the transmitting device group is configured into one packet, so that the receiving devices can conveniently receive the multiple communication link information corresponding to multiple transmitting devices in the transmitting device group.

As for the definition of the above packets and the configuration of the corresponding transmission processes, the master transmitting device is used as an intermediary between the M slave transmitting devices and the N receiving devices. On the one hand, the master transmitting device uniformly manages the configuration of the multiple communication links corresponding to the multiple transmitting devices in the transmitting device group. On the other hand, the master transmitting device transmits multiple different communication link information to the receiving devices at one time to realize construction of a composite communication link set for multi-point-to-multi-point communication in a point-to-multi-point communication form.

In one example, both the first communication link group and the second communication link group may be BLE Audio Broadcast Isochronous Group (BIG) links.

The first advertising channel and the second advertising channel are both periodic broadcast channels.

In one embodiment, the central link information comprises P enable parameters, which are in one-to-one correspondence with P auxiliary communication link groups. A parameter value of each enable parameter indicates whether the corresponding auxiliary communication link group is enabled. P is an integer greater than or equal to M, and each second communication link group is one enabled auxiliary communication link group.

The setting of the above enable parameters allows the master transmitting device to manage the slave transmitting devices more flexibly.

In one embodiment, the joint auxiliary synchronization data packet is a data packet in a common extended advertising payload format. An extended header of the joint auxiliary synchronization data packet carries the central link information, and the P enable parameters occupy part or all of bits in a reserved field of the central link information.

Exemplarily, the joint auxiliary synchronization data packet may be defined as a JBIG auxiliary synchronization (JBIG_AUX_SYNC_IND) PDU, the synchronized joint access data packet may be defined as a JBIG synchronized joint access (JBIG_SYNC_JOINT_ACCESS) PDU, the synchronized joint request data packet as a JBIG synchronized joint request (JBIG_SYNC_JOINT_REQ) PDU, the synchronized joint configuration data packet may be defined as a JBIG synchronized joint configuration (JBIG_SYNC_JOINT_CONFIG) PDU, and the synchronized joint response data packet may be defined as a JBIG synchronized joint response (JBIG_SYNC_JOINT_RSP) PDU.

The first communication link group is defined as a Central BIG (CBIG) link, and the second communication link group as an Assisted BIG (ABIG) link. The master transmitting device transmits audio data through the CBIG link, while the slave transmitting devices transmit audio data through the ABIG links. Each slave transmitting devices establish one corresponding ABIG link with the master transmitting device via Bidirectional Periodic Advertising (BPA) links, thereby forming a Joint Broadcast Isochronous Group (JBIG) link together with the CBIG link.

The JBIG_AUX_SYNC_IND PDU, similar to AUX_SYNC_IND PDU defined in a BLE specification, uses a common extended advertising payload format in the BLE specification, as shown in FIG. 2. This format comprises a 6-bit Extended Header Length, a 2-bit AdvMode, a 0-63-byte Extended Header, and up to 254 bytes of AdvData (Advertising Data).

As shown in FIG. 3, an extended header may comprise fields such as Extended Header Flags, AdvA, TargetA, CTEInfo, ADI, AuxPtr, SyncInfo, TxPower, and ACAD.

Extended Header Flags, as shown in FIG. 4, are extended header flag bits where each bit corresponds to a field of the extended header. A bit set to 1 indicates that corresponding field exists in the extended header, and a bit set to 0 indicates corresponding field does not exist in the extended header.

AdvA represents a device address of an advertising transmitting device, TargetA represents a device address of a target device, CTEInfo represents Constant Tone Extension (CTE) information, ADI represents advertising data information, AuxPtr represents an Auxiliary Advertising Pointer, SyncInfo represents synchronization information, TxPower represents transmit power, and ACAD represents Additional Controller Advertising Data (ACAD).

In related technologies, the AUX_SYNC_IND PDU carries BIG link information (BIG Info) through ACAD, wherein the BIG Info comprises an 8-bit reserved field (RFU: Reserved for Future Use).

In this example, the JBIG_AUX_SYNC_IND PDU carries CBIG Info (i.e., the central link information described above) through ACAD, and defines part or all of the bits in the reserved field of the CBIG Info as ABIG link enable bits (i.e., the enable parameters described above). These bits indicate whether the ABIG links are enabled and how many are enabled, numbered from low to high as ABIG EN_1, ABIG EN_2, . . . , ABIG EN_M.

Setting one ABIG link enable bit to 1 represents enabling the ABIG link corresponding to its sequence, while setting it to 0 indicates that the corresponding ABIG link is disabled or does not exist.

When one ABIG link enable bit is set to 1, the AdvData of the JBIG_AUX_SYNC_IND PDU carries the ABIG Info (i.e., the auxiliary link information described above) for the corresponding ABIG link. A definition of the ABIG Info for the ABIG link is the same as that of the BIG Info for the BIG link in the BLE specification. The ABIG Info for the ABIG links in the AdvData is arranged in sequential order, with ABIG1 Info corresponding to the first ABIG link and ABIGM Info corresponding to the Mth ABIG link.

In this example, referencing the BLE protocol, the CBIG Info and the ABIG Info are similar to the BIG Info, both used to provide the receiving devices with parameters such as a start point, number of links, an interval, an access address, and number of retransmissions for the CBIG link and the ABIG links. These details are not elaborated on further in this example.

The JBIG_SYNC_JOINT_ACCESS PDU, the JBIG_SYNC_JOINT_REQ PDU, the JBIG_SYNC_JOINT_CONFIG PDU, and the JBIG_SYNC_JOINT_RSP PDU are similar to the JBIG_AUX_SYNC_IND described, and all adopt the common extended advertising payload format shown in FIG. 2 under the BLE specification.

The differences between the JBIG_SYNC_JOINT_ACCESS PDU, the JBIG_SYNC_JOINT_REQ PDU, the JBIG_SYNC_JOINT_CONFIG PDU, the JBIG_SYNC_JOINT_RSP PDU and the JBIG_AUX_SYNC_IND PDU are reflected in the content of the Extended Header, the AdvMode, and the AdvData.

Specifically, the JBIG_SYNC_JOINT_ACCESS PDU differs from the JBIG_AUX_SYNC_IND PDU in that bit 0 of the Extended Header Flags in the JBIG_SYNC_JOINT_ACCESS PDU is set to 1, indicating that its extended header comprises an AdvA, wherein the AdvA is the device address of the master transmitting device.

The other fields of the JBIG_SYNC_JOINT_ACCESS PDU are the same as those of the JBIG_AUX_SYNC_IND PDU. The ACAD contains the CBIG Info for the CBIG link, wherein the enable bits of the ABIG links in the CBIG Info indicate enable status of the established ABIG links, and the AdvData carries the ABIG Info of the established ABIG links.

The AdvMode is set to 0b01, indicating an “Undirected Joint Available” type. Similar to the JBIG_AUX_SYNC_IND PDU, the JBIG_SYNC_JOINT_ACCESS PDU provides the CBIG Info and the ABIG Info of the established ABIG links to the slave transmitting devices, and is also used by the master transmitting device to allow the candidate transmitting device to access the JBIG link.

The JBIG_SYNC_JOINT_REQ PDU differs from the JBIG_AUX_SYNC_IND PDU in that bit 0 and bit 1 of the Extended Header Flags are set to 1, indicating that the extended header comprises both an AdvA and a TargetA. Here, the AdvA is the device address of the candidate transmitting device, and the TargetA is the device address of the master transmitting device. However, the ACAD of the JBIG_SYNC_JOINT_REQ PDU does not contain the CBIG Info, and the AdvData does not contain the ABIG Info; other fields are the same as those of the JBIG_AUX_SYNC_IND PDU. The AdvMode is set to 0b11, indicating a “Joint Request” type.

The AdvData of the JBIG_SYNC_JOINT_REQ PDU may carry information such as the device name of the candidate transmitting device or a Universally Unique Identifier (UUID).

The JBIG_SYNC_JOINT_REQ PDU is used by the candidate transmitting device to request the master transmitting device to allow it to establish a new ABIG link and join the JBIG link. The information for establishing the new ABIG link carried in the AdvData of the JBIG_SYNC_JOINT_REQ PDU comprises at least the ABIG Info expected to be set by the candidate transmitting device.

The JBIG_SYNC_JOINT_CONFIG PDU differs from the JBIG_AUX_SYNC_IND PDU in that bit 0 and bit 1 of the Extended Header Flags are set to 1, indicating that the extended header comprises both an AdvA and a TargetA, wherein the AdvA is the device address of the master transmitting device and the TargetA is the device address of the candidate transmitting device.

The other fields of the JBIG_SYNC_JOINT_CONFIG PDU are the same as those of the JBIG_AUX_SYNC_IND PDU: the ACAD field contains the CBIG Info for the CBIG link, the enable bits of the ABIG links in the CBIG Info indicate the enable status of the established ABIG links, and the AdvData carries the ABIG Info of the established ABIG links. The AdvMode is set to 0b10, indicating a “Directed Joint Available” type.

The JBIG_SYNC_JOINT_CONFIG PDU, like the JBIG_AUX_SYNC_IND PDU, provides the CBIG Info and the ABIG Info of the established ABIG links to the slave transmitting devices, and is also used by the master transmitting device to configure the ABIG Info for establishing the new ABIG link for the candidate transmitting device with a specified address.

The AdvData of the JBIG_SYNC_JOINT_CONFIG PDU also carries the confirmed ABIG Info of the newly established ABIG link. It is important to note that the confirmed ABIG Info of the newly established ABIG link may differ from the expected ABIG Info carried in the corresponding JBIG_SYNC_JOINT_REQ PDU, meaning the ABIG Info corresponding to the slave transmitting device is specified by the master transmitting device.

The JBIG_SYNC_JOINT_RSP PDU differs from the JBIG_AUX_SYNC_IND PDU in that bit 0 and bit 1 of the Extended Header Flags are set to 1, indicating that the extended header comprises both an AdvA and a TargetA. Here, the AdvA is the device address of the candidate transmitting device that has been determined as the slave transmitting device, and the TargetA is the device address of the master transmitting device.

However, the ACAD of the JBIG_SYNC_JOINT_RSP PDU does not contain the CBIG Info, and the AdvData does not contain the ABIG Info. Other fields are the same as those of the JBIG_AUX_SYNC_IND PDU.

The AdvMode is set to 0b00, indicating a “Clustering Response” type.

The JBIG_SYNC_JOINT_RSP PDU is used by the candidate transmitting device to respond to the master transmitting device's configuration for establishing the ABIG link and acknowledge joining the JBIG link.

In this example, the receiving device can synchronize with the master transmitting device by searching for the ADV_EXT_IND PDU transmitted by the master transmitting device on a primary advertising channel, then receiving the AUX_ADV_IND PDU transmitted by the master transmitting device on a secondary advertising channel, and then receiving the JBIG_AUX_SYNC_IND PDU transmitted by the master transmitting device on the second advertising channel, or receiving the JBIG_SYNC_JOINT_ACCESS PDU or the JBIG_SYNC_JOINT_CONFIG PDU transmitted by the master transmitting device on the first advertising channel. Through this process, the receiving device obtains the CBIG Info for the CBIG link, the enable status of the established ABIG links, and the corresponding ABIG Info for these ABIG links, so as to receive the BIS PDUs and their carried audio data over the CBIG link and the ABIG links.

The candidate transmitting device can synchronize with the master transmitting device by searching for the ADV_EXT_IND PDU transmitted by the master transmitting device on the primary advertising channel, receiving the AUX_ADV_IND PDU transmitted by the master transmitting device on the secondary advertising channel, and then receiving the JBIG_AUX_SYNC_IND PDU transmitted by the master transmitting device on the second advertising channel; or receiving the JBIG_SYNC_JOINT_ACCESS PDU or the JBIG_SYNC_JOINT_CONFIG PDU transmitted by the master transmitting device on the first advertising channel.

After the candidate transmitting device synchronizes with the master transmitting device, the candidate transmitting device forms the transmitting device group with the master transmitting device by transmitting and receiving the JBIG_SYNC_JOINT_ACCESS PDU, the JBIG_SYNC_JOINT_REQ PDU, the JBIG_SYNC_JOINT_CONFIG PDU, and the JBIG_SYNC_JOINT_RSP PDU. This process enables the candidate transmitting device to establish a new ABIG link, configure corresponding ABIG information (ABIG Info), and access the JBIG link.

The link through which the master transmitting device interacts the above PDUs with the candidate transmitting device or the slave transmitting devices to establish the ABIG link is defined as a Bidirectional Periodic Advertising (BPA) link.

Exemplarily, the master transmitting device can be set to enter a JBIG access mode automatically or through a User Interface (UI). After that, the master transmitting device will transmit the JBIG_SYNC_JOINT_ACCESS PDU on the first advertising channel. Upon receiving the JBIG_SYNC_JOINT_ACCESS PDU, the candidate transmitting device wishing to access the JBIG link of the master transmitting device with the corresponding device address will reply with the JBIG_SYNC_JOINT_REQ PDU after an interval of T_IFS to request establishment of the ABIG link and access to the JBIG link.

Here, T_IFS (Time of Inter Frame Space) can be set to 150 μs, or other values specified by future BLE protocols according to actual needs.

After receiving the JBIG_SYNC_JOINT_REQ PDU transmitted by the candidate transmitting device, if the master transmitting device confirms that the candidate transmitting device is allowed to establish the ABIG link and access the JBIG link according to the device address, the device name, or the UUID of the candidate transmitting device, the master transmitting device will transmit the JBIG_SYNC_JOINT_CONFIG PDU to the candidate transmitting device with the corresponding device address and configure the corresponding ABIG Info.

After receiving the JBIG_SYNC_JOINT_CONFIG PDU transmitted by the master transmitting device (at this point, the candidate transmitting device can be confirmed as the slave transmitting device), the candidate transmitting device immediately transmits the JBIG_SYNC_JOINT_RSP PDU after an interval of T_IFS to confirm access to the JBIG link.

If the master transmitting device does not receive the JBIG_SYNC_JOINT_RSP PDU replied by the slave transmitting device, it needs to retransmit the JBIG_SYNC_JOINT_CONFIG PDU until it correctly receives the JBIG_SYNC_JOINT_RSP PDU from the slave transmitting device.

After the slave transmitting device transmits the JBIG_SYNC_JOINT_RSP PDU, it can establish the corresponding ABIG link based on the ABIG Info configured in the JBIG_SYNC_JOINT_CONFIG PDU.

It should be emphasized that only the candidate transmitting device with the specified device address in the JBIG_SYNC_JOINT_CONFIG PDU can transmit the JBIG_SYNC_JOINT_RSP PDU after the T_IFS interval.

In addition, the ABIG Info configured by the JBIG_SYNC_JOINT_CONFIG PDU can be different from the ABIG Info expected by the JBIG_SYNC_JOINT_REQ PDU. In particular, an ABIG Offset and a Seed Access Address must be assigned and determined by the master transmitting device, the ABIG Offset is used to determine if the time slots overlap, and the Seed Access Address is used to determines if frequency hopping sequences of the frequency channels overlap.

To prevent interference caused by multiple candidate transmitting devices transmitting JBIG_SYNC_JOINT_REQ PDUs simultaneously, after receiving the JBIG_SYNC_JOINT_ACCESS PDU and synchronizing with the master transmitting device, each candidate transmitting device should generate a random delay, i.e., delaying several JBIG ISO Intervals (i.e., the equal time intervals mentioned above), each candidate transmitting device transmit the JBIG_SYNC_JOINT_REQ PDU only upon receiving the JBIG_SYNC_JOINT_ACCESS PDU again.

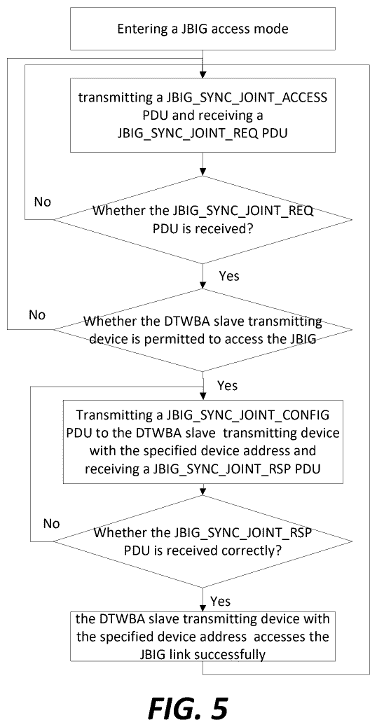

FIG. 5 illustrates a process by which the master transmitting device allows the candidate transmitting device to establish corresponding JBIG link.

After the master transmitting device enters a JBIG access mode, it first transmits a JBIG_SYNC_JOINT_ACCESS PDU and receives a JBIG_SYNC_JOINT_REQ PDU. If the JBIG_SYNC_JOINT_REQ PDU is not correctly received, it continues transmitting the JBIG_SYNC_JOINT_ACCESS PDU and waiting for the request.

If the JBIG_SYNC_JOINT_REQ PDU is received correctly and the master transmitting device permits the candidate transmitting device with the corresponding device address to access the JBIG link, the master transmitting device transmits a JBIG_SYNC_JOINT_CONFIG PDU to the candidate transmitting device with the specified device address and waits to receive a JBIG_SYNC_JOINT_RSP PDU (at this point, the candidate transmitting device can be considered to be one slave transmitting device). If the candidate transmitting device is not permitted, the master transmitting device continues transmitting the JBIG_SYNC_JOINT_ACCESS PDU to allow a new candidate transmitting device to access the JBIG link.

If the JBIG_SYNC_JOINT_RSP PDU is received correctly, the slave transmitting device with the specific device address accesses the JBIG link successfully. If not, the master transmitting device continues retransmitting the JBIG_SYNC_JOINT_CONFIG PDU until the JBIG_SYNC_JOINT_RSP PDU is received correctly or a timeout occurs.

Once the master transmitting device successfully establishes the JBIG link with the slave transmitting device with the specific device address, it continues transmitting the JBIG_SYNC_JOINT_ACCESS PDUs to allow other candidate transmitting devices to access the JBIG link, and repeats the above process of the candidate transmitting device accessing the JBIG link.

After the JBIG link has connected to the desired or predetermined number of slave transmitting devices, the master transmitting device exits the JBIG access mode, stops transmitting the JBIG_SYNC_JOINT_ACCESS PDU on the first advertising channel, and instead transmits the JBIG_AUX_SYNC_IND PDU on the second advertising channel. It is convenient for the receiving device to synchronize with the master transmitting device and obtain the CBIG Info and the ABIG Info.

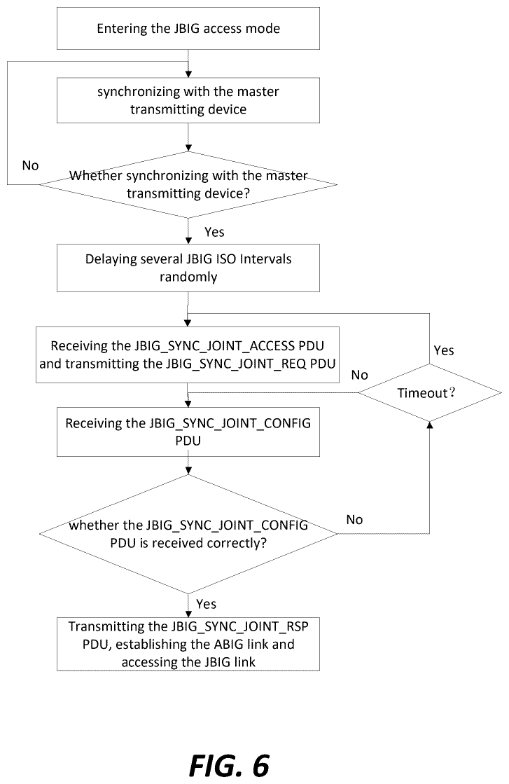

FIG. 6 illustrates a process for the candidate transmitting device to establish an ABIG link and access the JBIG link.

After entering the JBIG access mode, the candidate transmitting device first synchronizes with the master transmitting device, i.e., the candidate transmitting device searches for the ADV_EXT_IND PDU transmitted by the master transmitting device on the primary advertising channel, receives the AUX_ADV_IND PDU transmitted by the master transmitting device on the secondary advertising channel, and then receives the JBIG_SYNC_JOINT_ACCESS PDU transmitted by the master transmitting device on the periodic advertising channel to synchronize with the master transmitting device.

After synchronizing with the master transmitting device, to avoid interference caused by multiple candidate transmitting device simultaneously transmitting JBIG_SYNC_JOINT_REQ PDUs, each candidate transmitting device randomly delays for several JBIG ISO Intervals, then upon receiving the next JBIG_SYNC_JOINT_ACCESS PDU, transmits the JBIG_SYNC_JOINT_REQ PDU after a T_IFS interval.

To ensure reliability, the candidate transmitting device may also receive the JBIG_SYNC_JOINT_ACCESS PDU and transmit the JBIG_SYNC_JOINT_REQ PDU over multiple JBIG ISO Intervals.

Subsequently, the candidate transmitting device receives the JBIG_SYNC_JOINT_CONFIG PDU transmitted by the master transmitting device. If the JBIG_SYNC_JOINT_CONFIG PDU is successfully received, the candidate transmitting device replies with the JBIG_SYNC_JOINT_RSP PDU after an interval of T_IFS to confirm the establishment of the ABIG link and access to the JBIG link.

Otherwise, the candidate transmitting device continuously receives the JBIG_SYNC_JOINT_CONFIG PDU until a timeout occurs. After the timeout, it re-receives the JBIG_SYNC_JOINT_CONFIG PDU and transmits the JBIG_SYNC_JOINT_REQ PDU, repeating the above process until the ABIG link is established and access to the JBIG link is achieved.

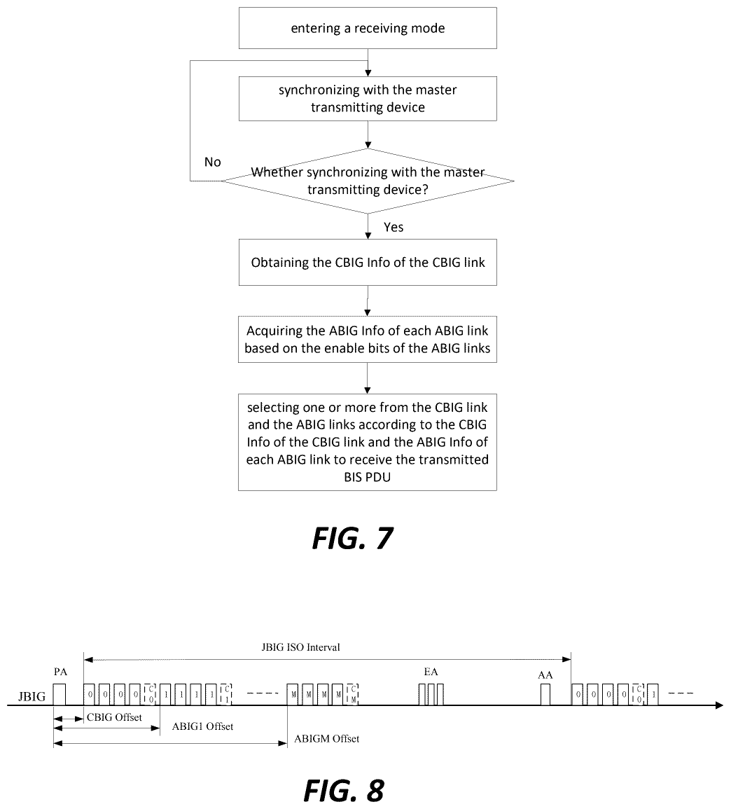

A workflow of the receiving device is shown in FIG. 7. After entering a receiving mode, the receiving device first synchronizes with the master transmitting device by sequentially receiving: the ADV_EXT_IND PDU transmitted by the master transmitting device on the primary advertising channel, the AUX_ADV_IND PDU transmitted by the master transmitting device on the secondary advertising channel, and the JBIG_AUX_SYNC_IND PDU transmitted by the master transmitting device on the second advertising channel (or the JBIG_SYNC_JOINT_ACCESS PDU and the JBIG_SYNC_JOINT_CONFIG PDU transmitted by the master transmitting device on the first advertising channel).

After synchronizing with the master transmitting device, the receiving device first obtains the CBIG Info of the CBIG link and the enable bits of the ABIG links within it, and acquires the ABIG Info of each ABIG link based on the enable bits of the ABIG links. The receiving device then selects one or more from the CBIG link and the ABIG links according to established rules to receive the transmitted BIS PDUs and the audio data carried by the BIS PDU.

In one embodiment, the continuous isochronous intervals comprise a first isochronous interval and a second isochronous interval, which are any two different intervals within the continuous isochronous intervals.

A time slot position occupied by the first broadcast data packet in the first isochronous interval is identical to a time slot position occupied by the first broadcast data packet in the second isochronous interval.

Additionally, the time slot position occupied by a target second broadcast data packet (any one of the multiple second broadcast data packets) in the first isochronous interval is the same as the time slot position occupied by the target second broadcast data packet in the second isochronous interval.

Through the above configuration, within the continuous isochronous intervals, the time slot positions allocated to each transmitting device across multiple continuous isochronous intervals are fixedly set, so as to avoid time slot configuration errors caused by time slot position changes and extra overhead caused by dynamic time slot position allocation, thereby facilitating the practical application of the method of the present disclosure.

Exemplarily, the time slot structure of the JBIG link where the CBIG link and the ABIG links do not overlap in time slots can be as shown in FIG. 8.

In FIG. 8, it is set that the JBIG link consists of one CBIG link and M (M≥1) ABIG links, the communication time of the JBIG link is divided into isochronous intervals each with a length of JBIG ISO Interval.

Within one JBIG ISO Interval, a box labeled “0” represents time slots for the CBIG link to transmit the BIS PDUs, and a box labeled “C0” (with a dashed line indicating it may or may not be transmitted in the current isochronous interval) represents the time slot for the CBIG link to transmit BIG Control PDUs. A box labeled “1” represents the time slots for the ABIG link numbered 1 (ABIG1) to transmit BIS PDUs, a box labeled “C1” represents the time slot for transmitting the BIG Control PDUs, a box labeled “M” represents the time slots for the ABIG link numbered M (ABIGM) to transmit the BIS PDUs, and a box labeled “CM” represents the time slot for transmitting the BIG Control PDUs.

The CBIG link and each ABIG link share the ADV_EXT_IND PDU (denoted as EA in FIG. 8) transmitted on the primary advertising channel, the AUX_ADV_IND PDU (denoted as AA in FIG. 8) transmitted on the secondary advertising channel, the JBIG_AUX_SYNC_IND PDU transmitted on the second advertising channel, and the JBIG_SYNC_JOINT_ACCESS PDU or the JBIG_SYNC_JOINT_CONFIG PDU (denoted as PA in FIG. 8) transmitted on the first advertising channel for receiving devices to synchronize.

In FIG. 8, a BIG offset (CBIG Offset) carried in the CBIG Info of the CBIG link is smaller than BIG offsets (ABIG1 Offset, . . . , ABIGM Offset) carried in the ABIG Info of the ABIG links, indicating that the BIS PDU of the CBIG link is transmitted first and then the BIS PDU of the ABIG link is transmitted.

In one example, the CBIG link and the ABIG link may also be set to overlap each other in the time slot but not overlap each other in the frequency channel, so as to save the time slot resources, thereby adapting to demand of the scene requiring a wireless audio source. For example, the JBIG master device (comprising the master transmitting device and the slave transmitting device) needs to acquire wireless audio through Classic BT in a frequency division multiplexing manner, and the CBIG master device (referring to the master transmitting device) and the ABIG master device (referring to the slave transmitting device) need to share audio data through a BLE CIG link in a frequency division multiplexing manner.

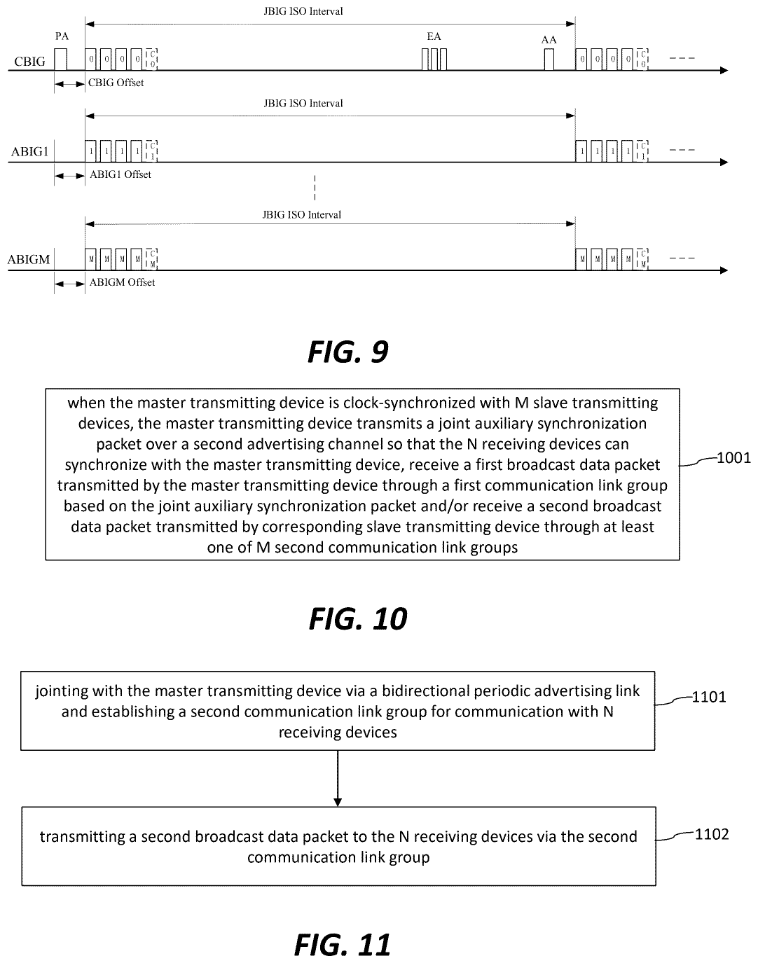

The time slot structure of the JBIG link where the CBIG link and the ABIG links overlap in the time slot but do not overlap in the frequency channel can be as shown in FIG. 9. For descriptions of relevant symbols in FIG. 9, refer to explanations in FIG. 8. To avoid repetition, the detailed descriptions are not repeated here.

In one embodiment, the M slave transmitting devices comprise a target slave transmitting device. The target slave transmitting device adjusts its clock based on the target data packet transmitted by the master transmitting device, so that a clock of the target slave transmitting device synchronizes with a clock of the master transmitting device.

The target data packet is a packet transmitted by the master transmitting device via the first advertising channel and/or a packet transmitted by the master transmitting device via the second advertising channel.

The first advertising channel is a channel used to determine the slave transmitting devices, and the second advertising channel is a channel used by the receiving devices to synchronize with the master transmitting device.

In this application, data packets transmitted by the master transmitting device over the first advertising channel comprise the synchronized joint access data packet and the synchronized joint configuration data packet, while data packets transmitted over the second advertising channel comprise the joint auxiliary synchronization data packet. As previously described, these three types of packets (the synchronized joint access data packet, the synchronized joint configuration data packet, and the joint auxiliary synchronization data packet) all contain the CBIG Info for the CBIG link. The enable bits of the ABIG links in the CBIG Info indicate the enable status of established ABIG links, and the packets carry the ABIG Info of these established ABIG links. Therefore, the slave transmitting devices can continuously receive these three types of packets to adjust their clocks, ensuring that their clocks remain synchronized with the master transmitting device's clock or that each ABIG Offset remains relatively unchanged. This maintains relative stability of the transmission time slots for the ABIG links and the CBIG link, thereby avoiding overlap between the transmission time slots of the ABIG links and the CBIG link due to clock drift and thus preventing audio desynchronization between the ABIG links and the CBIG link.

A wireless audio data transmission method applied to a master transmitting device is provided according to one embodiment. The master transmitting device performs broadcast communication with N receiving devices within continuous isochronous intervals to transmit an audio stream, with N being a positive integer. As shown in FIG. 10, the method comprises: when the master transmitting device is clock-synchronized with M slave transmitting devices, the master transmitting device transmits a joint auxiliary synchronization data packet over a second advertising channel so that the N receiving devices can synchronize with the master transmitting device, receive a first broadcast data packet transmitted by the master transmitting device through a first communication link group based on the joint auxiliary synchronization data packet and/or receive a second broadcast data packet transmitted by corresponding slave transmitting device through at least one of M second communication link groups at 1001.

The M second communication link groups correspond one-to-one with the M slave transmitting devices, wherein M is a positive integer.

Within the continuous isochronous intervals, the first broadcast data packet generated based on a target audio frame is a target first broadcast data packet, and the second broadcast data packet generated based on the target audio frame for a target slave transmitting device is a target second broadcast data packet. The target audio frame is any audio frame in the audio stream, the target slave transmitting device is any one of the M slave transmitting devices, and the audio data carried by the target first broadcast data packet is the same as that carried by the target second broadcast data packet.

In one embodiment, among the first broadcast data packet and/or at least one second broadcast data packet transmitted within the same isochronous interval, the time slots occupied by any two different broadcast data packets do not overlap, and/or the frequency channels occupied by any two different broadcast data packets do not overlap.

In one embodiment, the method further comprises: transmitting a synchronized joint access data packet via a first advertising channel and receiving a synchronized joint request data packet carrying request link information fed back by a candidate transmitting device in response to the synchronized joint access data packet, the request link information comprising a device address and/or a device identifier of the candidate transmitting device; transmitting a synchronized joint configuration data packet carrying configuration link information to the candidate transmitting device when the master transmitting device determines that the candidate transmitting device is permitted to join the transmitting device group based on the device address and/or the device identifier; receiving a synchronized joint response data packet fed back by the candidate transmitting device in response to the synchronized joint configuration data packet and designating the candidate transmitting device as one slave transmitting device, wherein the candidate transmitting device is configured to establish corresponding second communication link group based on the configuration link information.

In one embodiment, the joint auxiliary synchronization data packet comprises central link information of the first communication link group, wherein the first communication link group is a communication link group for transmitting the first broadcast data packet.

The joint auxiliary synchronization data packet comprises M auxiliary link information for M second communication link groups. The M auxiliary link information corresponds one-to-one to the M slave transmitting devices, and the second communication link group is a communication link group for transmitting the second broadcast data packet.

In one embodiment, the central link information comprises P enable parameters, wherein the P enable parameters are in one-to-one correspondence with P auxiliary communication link groups; a parameter value of each enable parameter is used to indicate whether the corresponding auxiliary communication link group is enabled; P is an integer greater than or equal to M, and the second communication link group is one enabled auxiliary communication link group.

The joint auxiliary synchronization data packet is a packet in a common extended advertising payload format, an extended header of the joint auxiliary synchronization data packet carries the central link information, and the P enable parameters occupy some or all bits of a reserved field in the central link information.

In one embodiment, any two different isochronous intervals within the continuous isochronous intervals are a first isochronous interval and a second isochronous interval.

The time slot position occupied by the first broadcast data packet in the first isochronous interval is the same as the time slot position occupied by the first broadcast data packet in the second isochronous interval.

Additionally, the time slot position occupied by the target second broadcast data packet (any one of the multiple second broadcast data packets) in the first isochronous interval is the same as the time slot position occupied by the target second broadcast data packet in the second isochronous interval.

In one embodiment, the method further comprises: transmitting a target data packet to the slave transmitting device so that the slave transmitting device adjusts its clock based on the target data packet to synchronize its clock with the clock of the master transmitting device.

The target slave transmitting device is any one of the M slave transmitting devices, and the target data packet is a data packet transmitted by the master transmitting device over the first advertising channel and/or the second advertising channel.

The first advertising channel is a channel used for determining the slave transmitting device, and the second advertising channel is a channel used for the receiving device to synchronize with the master transmitting device.

The wireless audio data transmission method provided in this embodiment corresponds to processes involving the master transmitting device in the aforementioned embodiments and can achieve the same technical effects. To avoid repetition, detailed descriptions are not repeated here.

A wireless audio data transmission method applied to a candidate transmitting device is provided according to one embodiment. As shown in FIG. 11, the method comprises: jointing with a master transmitting device via a bidirectional periodic advertising link and establishing a second communication link group for communication with N receiving devices at 1101; and transmitting a second broadcast data packet to the N receiving devices via the second communication link group at 1102.

The master transmitting device is configured to perform broadcast communication with the N receiving devices over a first communication link group within continuous isochronous intervals to transmit an audio stream, wherein N is a positive integer.

The master transmitting device transmits the first broadcast data packet to the N receiving devices via the first communication link group. Within the continuous isochronous intervals, the first broadcast data packet generated based on a target audio frame is a target first broadcast data packet, and the second broadcast data packet generated based on the target audio frame is a target second broadcast data packet. The target audio frame is any audio frame in the audio stream, and the audio data carried by the target first broadcast data packet is the same as that carried by the target second broadcast data packet.

In one embodiment, among the first broadcast data packet and/or at least one second broadcast data packet transmitted within the same isochronous interval, the time slots occupied by any two different broadcast data packets do not overlap, and/or the frequency channels occupied by any two different broadcast data packets do not overlap.

In one embodiment, an operation of “transmitting a second broadcast data packet to the N receiving devices via the second communication link group” comprises: processing an audio frame of an audio stream based on predefined encapsulation parameter information to generate the second broadcast data packet; transmitting the second broadcast data packet to the N receiving devices via the second communication link group. The first broadcast data packet is generated by processing the audio frame of the audio stream based on the same predefined encapsulation parameter information.

In one embodiment, an operation of “jointing with a master transmitting device via a bidirectional periodic advertising link and establishing a second communication link group for communication with the N receiving devices” comprises: receiving a synchronized joint access data packet transmitted by the master transmitting device via the bidirectional periodic advertising link; transmitting a synchronized joint request data packet carrying request link information comprising a device address and/or a device identifier of the candidate transmitting device to the master transmitting device via the bidirectional periodic advertising link in response to the synchronized joint access data packet; receiving a synchronized joint configuration data packet carrying configuration link information transmitted by the master transmitting device via the bidirectional periodic advertising link when the master transmitting device determines that the candidate transmitting device is permitted to joint with the master transmitting device based on the device address and/or the device identifier; and transmitting a synchronized joint response data packet to the master transmitting device via the bidirectional periodic advertising link, thereby designating the candidate transmitting device as the slave transmitting device jointing with the master transmitting device, and establishing the second communication link group based on the configuration link information.

The wireless audio data transmission method provided in this embodiment corresponds to the processes involving the candidate transmitting device in the aforementioned embodiments and can achieve the same technical effects. To avoid repetition, detailed descriptions are not repeated here.

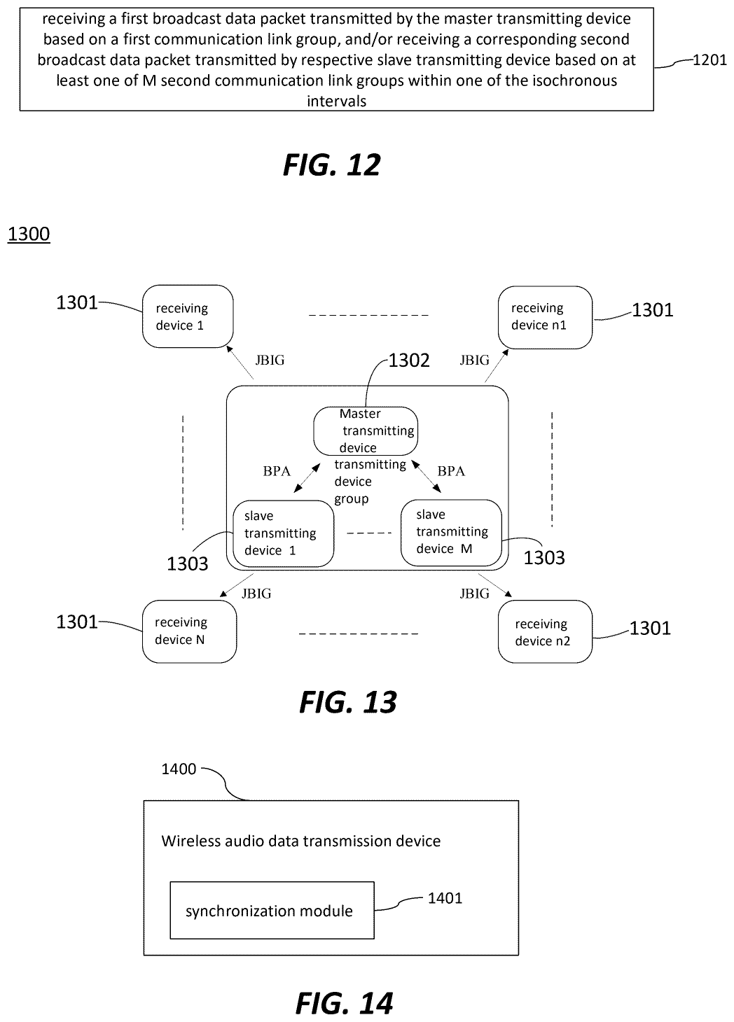

A wireless audio data transmission method applied to a receiving device is provided according to one embodiment of the present disclosure. A transmitting device group comprises a master transmitting device and M slave transmitting devices synchronized in clock with the master transmitting device, wherein M is a positive integer. The transmitting devices in the transmitting device group and the receiving device perform broadcast communication within continuous isochronous intervals to transmit an audio stream. As shown in FIG. 12, the method comprises: within one of the isochronous intervals, receiving a first broadcast data packet transmitted by the master transmitting device based on a first communication link group, and/or receiving a corresponding second broadcast data packet transmitted by respective slave transmitting device based on at least one of M second communication link groups at 1201.

The M second communication link groups correspond one-to-one with the M slave transmitting devices.

Within the continuous isochronous intervals, the first broadcast data packet generated based on a target audio frame is a target first broadcast data packet, and the second broadcast data packet generated based on the target audio frame for a target slave transmitting device is a target second broadcast data packet. The target audio frame is any audio frame in the audio stream, the target slave transmitting device is any one of the M slave transmitting devices, and the audio data carried by the target first broadcast data packet is the same as that carried by the target second broadcast data packet.

In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

In one embodiment, among the first broadcast data packet and/or at least one second broadcast data packet transmitted within the same isochronous interval, the time slots occupied by any two different broadcast data packets do not overlap, and/or the frequency channels occupied by any two different broadcast data packets do not overlap.

In one embodiment, an operation of “receiving a first broadcast data packet transmitted by the master transmitting device based on a first communication link group, and/or receiving a corresponding second broadcast data packet transmitted by respective slave transmitting device based on at least one of M second communication link groups” comprises: determining Q target communication link groups with the highest channel quality from the first communication link group and the M second communication link groups, wherein Q is a positive integer; receiving at least one target broadcast data packet corresponding to the Q target communication link groups, wherein the target broadcast data packet is the first broadcast data packet or the second broadcast data packet.

In one embodiment, an operation of “determining Q target communication link groups with the highest channel quality from the first communication link group and the M second communication link groups” comprises: determining the Q target communication link groups based on communication performance of each communication link group among the first communication link group and the M second communication link groups, wherein Q is a positive integer less than M+1. The Q target communication link groups are the top Q communication link groups in terms of communication performance sorted from highest to lowest among the first communication link group and the M second communication link groups.

The receiving device may also select the Q target communication link groups (i.e., one or a limited number of link groups with the best communication performance) from the CBIG link and the ABIG links to receive their BIS PDUs, thereby improving the communication performance or the transmission reliability of the WBA (Wireless Broadcast Audio) through transmission spatial diversity (where the fading of transmitters at different spatial positions is independent).

For a JBIG link time slot structure shown in FIG. 9, the receiving device supporting multiple frequency channel parallel reception paths may select a limited number (fewer than the total number of link groups) or all link groups with the best communication performance from the CBIG link and the ABIG links to receive their BIS PDUs, thereby improving the communication performance of the WBA or the transmission reliability of the WBA through transmission space diversity.

For the receiving device with only a single frequency channel reception path, the receiving device selects the single link group with the best communication performance from the CBIG link and the ABIG links to receive the BIS PDU, thereby achieving spatial diversity to improve the communication performance or the transmission reliability of the WBA.

The communication performance is evaluated based on a received signal strength or a Packet Error Rate (PER). For example, stronger received signals or lower PER indicate better communication performance. When selecting one or a limited number of link groups, the receiving device may utilize idle time to alternately receive the BIS PDU from each link group to assess their communication performance.

It should be understood that for the JBIG link time slot structure shown in FIG. 8, the receiving device may sequentially receive the BIS PDUs from the CBIG link and the ABIG links within each JBIG ISO Interval until the audio data for the current JBIG ISO Interval is correctly received or the BIS PDUs of all links are received. This not only increases the number of retransmissions for the same audio data but also leverages multiple transmitting devices to achieve spatial diversity gain, thereby enhancing the communication performance or the transmission reliability of the WBA.

In one embodiment, before the operation of “receiving a first broadcast data packet transmitted by the master transmitting device based on a first communication link group, and/or receiving a corresponding second broadcast data packet transmitted by respective slave transmitting device based on at least one of M second communication link groups”, the method further comprises: receiving a joint auxiliary synchronization data packet transmitted by the master transmitting device over a second advertising channel, wherein the joint auxiliary synchronization data packet comprises central link information of the first communication link group and M auxiliary link information for M second communication link groups; synchronizing with the master transmitting device based on the joint auxiliary synchronization data packet.

In one embodiment, the central link information comprises P enable parameters, wherein the P enable parameters correspond one-to-one with P auxiliary communication link groups. The parameter value of each enable parameter indicates whether the corresponding auxiliary communication link group is enabled. P is an integer greater than or equal to M, and the second communication link group is one enabled auxiliary communication link group.

The wireless audio data transmission method provided in this embodiment corresponds to the processes involving the receiving device in the aforementioned embodiments and can achieve the same technical effects. To avoid repetition, detailed descriptions are not repeated here.

A wireless audio data transmission system is provided according to one embodiment of the present disclosure, as shown in FIG. 13. The wireless audio data transmission system 1300 comprises: a transmitting device group and N receiving devices 1301, wherein the transmitting device group comprises a master transmitting device 1302 and M slave transmitting devices 1303 that are clock-synchronized with the master transmitting device. N and M are both positive integers, and N≥n2≥n1≥1.

The transmitting devices in the transmitting device group and the N receiving devices 1301 perform broadcast communication within continuous isochronous intervals to transmit an audio stream.

Within one of the isochronous intervals, the master transmitting device 1302 transmits a first broadcast data packet to the N receiving devices 1301 based on a first communication link group, and/or at least one slave transmitting device 1303 among the M slave transmitting devices 1303 transmits a corresponding second broadcast data packet to the N receiving devices 1301 based on the corresponding second communication link group.

Within the continuous isochronous intervals, the first broadcast data packet generated based on a target audio frame is a target first broadcast data packet, the second broadcast data packet generated based on the target audio frame for a corresponding target slave transmitting device is a target second broadcast data packet, the target audio frame is any audio frame in the audio stream, the target slave transmitting device is any one of the M slave transmitting devices 1303, and the audio data carried by the target first broadcast data packet is the same as the audio data carried by the target second broadcast data packet.

In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

Among the first broadcast data packet and/or at least one second broadcast data packet transmitted within the same isochronous interval, the time slots occupied by any two different broadcast data packets do not overlap, and/or the frequency channels occupied by any two different broadcast data packets do not overlap.

In one embodiment, both the first communication link group and the second communication link group are Broadcast Isochronous Group (BIG) links.

The wireless audio data transmission system provided in this embodiment corresponds to the processes involving the master transmitting device, the candidate transmitting device, and the receiving device in the aforementioned embodiments, and can achieve the same technical effects. To avoid repetition, detailed descriptions are not repeated here.

The wireless broadcast audio solution with multiple transmitting devices proposed in the present disclosure may be referred to as Distributed Transmitters Wireless Broadcast Audio (DTWBA).

For ease of understanding, an example is provided as follows.

Take a café's distributed wireless audio system as an example to illustrate transmission and reception methods of a DTWBA (Distributed Transmitters Wireless Broadcast Audio) system.

In this example, the transmitting devices in the DTWBA system comprise an audio playback platform and a relay device, while the receiving devices are multiple wireless speakers.

The audio playback platform serves as the master transmitting device, such as a computer or a smartphone with cloud-based audio playback software.

The relay device serves as one slave transmitting device, supporting wireless audio source reception.

The JBIG link between the transmitting devices and the receiving devices consists of one CBIG link and one ABIG link (ABIG1). The master transmitting device transmits audio data through the CBIG link, and the slave transmitting device transmits audio data through the ABIG1 link. In addition to achieving synchronization and establishing the JBIG link via the BPA (Bidirectional Periodic Advertising) link, the DTWBA master transmitting device and the DTWBA slave transmitting device also transmit audio data or share the same audio data through a point-to-point wireless connection.

Without loss of generality, in this example, the point-to-point wireless connection is a CIG (Continuous Isochronous Group) link based on the BLE (Bluetooth Low Energy) protocol. In addition to transmitting the audio stored locally or from the cloud to the receiving device through the CBIG link, the master transmitting device also transmits the same audio data to the slave transmitting device through the CIG link in a time division multiplexing manner, and then the slave transmitting device transmits the audio data to the receiving device through the ABIG1 link.

The master transmitting device and the slave transmitting device share the same audio data by using the CIG link, and the master transmitting device uses the same BLE radio frequency unit to receive and transmit the data packets of the CIG link and the CBIG link in the time division multiplexing manner, and the slave transmitting device also uses the same BLE radio frequency unit to receive and transmit the data packets of the CIG link and the ABIG1 link in the time division multiplexing manner. The time slot structure of the JBIG link in this embodiment is similar to that shown in FIG. 9, that is, the CBIG link and the ABIG1 link overlap each other in the time slots but do not overlap each other in the frequency channels.

In the time slot structure of the JBIG link in this example, the main parameters of the CBIG link comprise that a frame length of LC3 coding of digital audio with a sampling rate of 48 KHz of two channels (the left channel and the right channel) is 10 ms, a coding rate is 96 kbps, a size of a service data unit (SDU) is 130 bytes, the isochronous interval (ISO Interval) of the CBIG is the same as the JBIG ISO Interval, which is equal to 20 ms, the number of BIS links is 1, the number of Sub-event (NSE) is equal to 6, burst number (BN: Burst Number) is equal to 2, an immediate repetition count is equal to 3, Pre-Transmission Offset (PTO) value is equal to 0.

A payload size of the BIS PDU is 240 bytes, containing two SDUs (one left-channel SDU and one right-channel SDU). The interval or occupied air time slot for each BIS PDU is 1.2 ms, and 6 BIS PDUs occupy a total of 7.2 ms.

Transmission uses a BLE 2 Mbps physical layer. The periodic advertising interval is 60 ms, and an offset value (CBIG Offset) between a start of the periodic advertising and a start of the CBIG is 1.23 ms. The above information is comprised in the CBIG Info.

The CBIG Offset of the CBIG link is also the same as the ABIG1 Offset of the ABIG1 link. Without loss of generality, the ABIG Info of the ABIG1 link is completely identical to the CBIG Info of the CBIG link, except for differences in the Seed Access Address and the ABIG enable bit.

The main parameters of the ABIG1 link comprise: a frame length of LC3 coding of digital audio with a sampling rate of 48 KHz of two channels (the left channel and the right channel) is 10 ms, a coding rate is 96 kbps, a size of a service data unit (SDU) is 130 bytes, the isochronous interval (ISO Interval) of the ABIG1 is the same as the JBIG ISO Interval, which is equal to 20 ms, the number of BIS links is 1, the number of sub-events (NSE) is equal to 6, the burst number (BN: Burst Number) is equal to 2, an immediate repetition count (IRC: Immediate Repetition Count) is equal to 3, Pre-Transmission Offset (PTO) value is equal to 0.

The payload size of the BIS PDU is 240 bytes, containing two SDUs (one left-channel SDU and one right-channel SDU). The interval or occupied air time slot for each BIS PDU is 1.2 ms, and 6 BIS PDUs occupy a total of 7.2 ms. Transmission uses the BLE 2 Mbps physical layer. The offset value (ABIG1 Offset) between the start of the periodic advertising and the start of the ABIG1 is 1.23 ms. The above information is also included in the ABIG1 Info.

Since the JBIG link and the CIG link between the master transmitting device and the slave transmitting device coexist in the time division multiplexing manner, within each JBIG ISO Interval, in addition to the time slots occupied by the JBIG link, part or all of the remaining time slots are allocated to the CIG link.

Note that since the CBIG link and the ABIG1 link overlap each other in time slots, even if different Seed Access Address are used, the same frequency channel is occasionally generated to cause a problem of mutual interference. Therefore, the ABIG1 link needs to transmit the corresponding BIS PDU by offsetting a certain frequency channel on the basis of the frequency channel according to a preset rule to avoid mutual interference, so as to ensure that the BIS PDU transmitted by the CBIG and the ABIG1 are not overlapped on the frequency channel.

Without loss of generality, the preset rule in this example obtains the new frequency channel of the ABIG1 link by fixing an offset of 12. If the offset of 12 exceeds the total number of channels, the new frequency channel is obtained by subtracting the total number of channels.

The audio playback platform and the relay device establish the JBIG link consisting of one CBIG link and one ABIG link according to the process for the master transmitting device to establish the JBIG link as shown in FIG. 5 and the process for the candidate transmitting device to access the JBIG link as shown in FIG. 6, respectively.

After the JBIG link is established, in the JBIG_AUX_SYNC_IND PDU transmitted by the audio playback platform, the least significant bit of the ABIG enable bits in the CBIG Info contained in the ACAD field is set to 1, indicating that one ABIG link is established, and the JBIG_AUX_SYNC_IND PDU carries the ABIG1 Info in the AdvData field. During the establishment of the ABIG1 link between the audio playback platform and the relay device, the ABIG1 Info carried in the JBIG_SYNC_JOINT_REQ PDU matches the ABIG1 Info configured in the JBIG_SYNC_JOINT_CONFIG PDU for all parameters except the ABIG enable bits, the ABIG1 Offset, and the Seed Access Address.

Without loss of generality, in this example, the wireless speakers in the distributed wireless audio system do not support simultaneous reception on multiple frequency channels and thus cannot receive the BIS PDUs from both the CBIG link and the ABIG1 link at the same time. Therefore, following the workflow of the DTWBA receiving device shown in FIG. 7, the wireless speakers first synchronize with the audio playback platform to obtain the CBIG Info of the CBIG link and the ABIG enable bits therein, and then acquire the ABIG1 Info of the ABIG1 link based on the ABIG link enable bits. They then select one link with the best communication performance between the CBIG link and the ABIG1 link to receive the BIS PDUs and the carried audio data. Then, the received audio data is decoded and played after some sound effect processing.

In this example, in response to the problem of relative drift in the clocks of the audio playback platform and the relay device, the relay device continuously receives the JBIG_AUX_SYNC_IND PDU transmitted by the audio playback platform on the periodic advertising channel to adjust its clock to match the audio playback platform's clock or maintain the ABIG1 Offset unchanged. This ensures that the transmission time slots of the ABIG1 link and the CBIG link remain relatively constant, thereby avoiding overlap between the time slots of the ABIG1 link and the time slots of the CBIG link due to clock drift, as well as preventing audio playback desynchronization in different wireless speakers that respectively receive the BIS PDUs from the CBIG link and the ABIG1 link.

A wireless audio data transmission device applied to a master transmitting device is provided according to one embodiment of the present disclosure, wherein the master transmitting device communicates with N receiving devices in continuous isochronous intervals to transmit an audio stream, and N is a positive integer. As shown in FIG. 14, the device 1400 comprises: a synchronization module 1401, configured to transmit a joint auxiliary synchronization data packet based on a second advertising channel so that the N receiving devices is synchronized with the master transmitting device, can receive a first broadcast data packet transmitted by the master transmitting device via a first communication link group based on the joint auxiliary synchronization data packet, and/or receive corresponding second broadcast data packet transmitted by at least one of the M slave transmitting devices via a corresponding second communication link group when the master transmitting device is clock-synchronized with M slave transmitting devices. The M second communication link groups correspond one-to-one with the M slave transmitting devices, and M is a positive integer.

Within the continuous isochronous intervals, a first broadcast data packet generated based on a target audio frame is a target first broadcast data packet, and a second broadcast data packet generated based on the target audio frame by a corresponding target slave transmitting device is a target second broadcast data packet. The target audio frame is any audio frame in the audio stream, the target slave transmitting device is any one of the M slave transmitting devices, and the audio data carried by the target first broadcast data packet is the same as the audio data carried by the target second broadcast data packet. In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

In one embodiment, among the first broadcast data packet and/or at least one second broadcast data packet transmitted within the same isochronous interval, time slots occupied by any two different broadcast data packets are not overlapped with each other, and/or frequency domain channels occupied by any two different broadcast data packets are not overlapped with each other.

In one embodiment, the device 1400 further comprises a joint module.

The joint module is specifically configured for: transmitting a synchronized joint access data packet via a first advertising channel and receiving a synchronized joint request data packet carrying request link information fed back by a candidate transmitting device in response to the synchronized joint access data packet, the request link information comprising a device address and/or a device identifier of the candidate transmitting device; transmitting a synchronized joint configuration data packet carrying configuration link information to the candidate transmitting device when the master transmitting device determines that the candidate transmitting device is permitted to join the transmitting device group based on the device address and/or the device identifier; receiving a synchronized joint response data packet fed back by the candidate transmitting device in response to the synchronized joint configuration data packet and designating the candidate transmitting device as one slave transmitting device, wherein the candidate transmitting device is configured to establish corresponding second communication link group based on the configuration link information.

In one embodiment, the joint auxiliary synchronization data packet comprises central link information of the first communication link group, and the first communication link group is a communication link group for transmitting the first broadcast data packet.

The joint auxiliary synchronization data packet comprises M auxiliary link information for the M second communication link groups. The M auxiliary link information correspond one-to-one with the M slave transmitting devices, and the second communication link is a communication link group for transmitting the second broadcast data packet.

In one embodiment, the central link information comprises P enable parameters, and the P enable parameters are in one-to-one correspondence with P auxiliary communication link groups. The parameter value of each enable parameter is used to indicate whether the corresponding auxiliary communication link group is enabled; P is an integer greater than or equal to M, and the second communication link group is one enabled auxiliary communication link group.

The joint auxiliary synchronization data packet is a data packet in a common extended advertising payload format; an extended header of the joint auxiliary synchronization data packet carries the central link information; and the P enable parameters occupy part or all of bits in a reserved field of the central link information.

In one embodiment, the continuous isochronous intervals comprise a first isochronous interval and a second isochronous interval, which are any two different isochronous intervals among the continuous isochronous intervals.

A time slot position occupied by the first broadcast data packet in the first isochronous interval is identical to a time slot position occupied by the first broadcast data packet in the second isochronous interval.

The time slot position occupied by a target second broadcast data packet in the first isochronous interval is the same as the time slot position occupied by the target second broadcast data packet in the second isochronous interval, wherein the target second broadcast data packet is any one of the multiple second broadcast data packets.

In one embodiment, the device 1400 further comprises a clock synchronization module.

The clock synchronization module is specifically configured for transmitting a target data packet to the slave transmitting device so that the slave transmitting device adjusts its clock based on the target data packet to synchronize its clock with the clock of the master transmitting device.

The target slave transmitting device is any one of the M slave transmitting devices, the target data packet is a data packet transmitted by the master transmitting device via the first advertising channel and/or the second advertising channel.

The first advertising channel is a channel used to determine the slave transmitting devices, and the second advertising channel is a channel used by the receiving devices to synchronize with the master transmitting device.

The wireless audio data transmission device 1400 provided in this embodiment can implement each process of the wireless audio data transmission method on a master transmitting device side, and details are not repeated here to avoid redundancy.

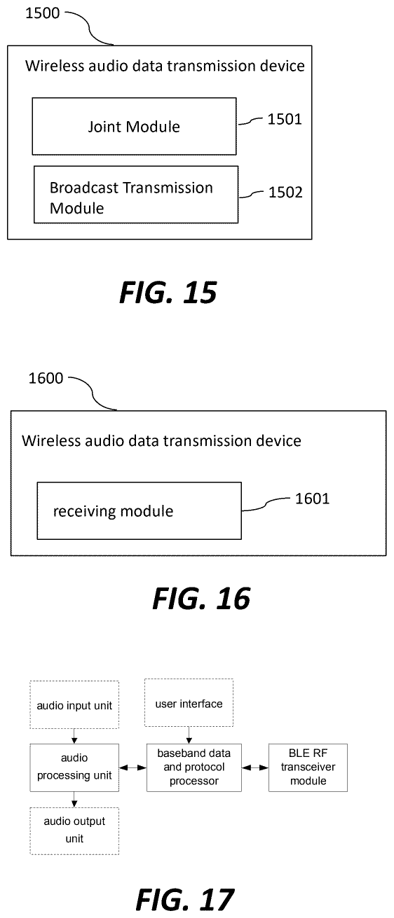

A wireless audio data transmission device applied to a candidate transmitting device is provided according to one embodiment of the present disclosure. As shown in FIG. 15, the device 1500 comprises: a joint module 1501 configured for jointing with a master transmitting device via a bidirectional periodic advertising link and establishing a second communication link group for communication with N receiving devices, wherein the master transmitting device is configured to transmits a first broadcast data packet to the N receiving devices via a first communication link group in continuous isochronous intervals, and N is a positive integer; a broadcast transmission module 1502 configured for transmitting a second broadcast data packet to the N receiving devices based on the second communication link group.

Wherein, the master transmitting device transmits the first broadcast data packets to the N receiving devices via the first communication link group. In the continuous isochronous intervals, the first broadcast data packet generated based on a target audio frame is a target first broadcast data packet, and the second broadcast data packet generated based on the target audio frame is a target second broadcast data packet. The target audio frame is any audio frame in the audio stream, and the audio data carried by the target first broadcast data packet is the same as the audio data carried by the target second broadcast data packet.

In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

In one embodiment, among the first broadcast data packet and/or at least one second broadcast data packet transmitted within the same isochronous interval, time slots occupied by any two different broadcast data packets are not overlapped with each other, and/or frequency domain channels occupied by any two different broadcast data packets are not overlapped with each other.

In one embodiment, the broadcast transmission module 1502 is specifically configured for: processing an audio frame of an audio stream based on predefined encapsulation parameter information to generate the second broadcast data packet; transmitting the second broadcast data packet to the N receiving devices based on the second communication link group.

The first broadcast data packet is generated by processing the audio frame of the audio stream based on the same predefined encapsulation parameter information.

In one embodiment, the joint module 1501 is specifically configured for: receiving a synchronized joint access data packet transmitted by the master transmitting device via the bidirectional periodic advertising link; transmitting a synchronized joint request data packet carrying request link information comprising a device address and/or a device identifier of the candidate transmitting device to the master transmitting device via the bidirectional periodic advertising link in response to the synchronized joint access data packet; receiving a synchronized joint configuration data packet carrying configuration link information transmitted by the master transmitting device via the bidirectional periodic advertising link when the master transmitting device determines that the candidate transmitting device is permitted to joint with the master transmitting device based on the device address and/or the device identifier; transmitting a synchronized joint response data packet to the master transmitting device via the bidirectional periodic advertising link, thereby designating the candidate transmitting device as the slave transmitting device jointing with the master transmitting device, and establishing the second communication link group based on the configuration link information.

The wireless audio data transmission device 1500 provided in this embodiment can implement each process of the wireless audio data transmission method on a candidate transmitting device side, and details are not repeated here to avoid redundancy.

A wireless audio data transmission device applied to a receiving device is provided according to one embodiment of the present disclosure. Transmitting devices in a transmitting device group communicate with the receiving device in continuous isochronous intervals to transmit an audio stream. The transmitting device group comprises a master transmitting device and M slave transmitting devices synchronized with the master transmitting device in clock, wherein M is a positive integer. As shown in FIG. 16, the device 1600 comprises: a receiving module 1601 configured to receive a first broadcast data packet transmitted by the master transmitting device based on a first communication link group, and/or receive corresponding second broadcast data packet transmitted by at least one of the M slave transmitting devices based on at least one of the M second communication link groups within one isochronous interval. The M second communication link groups correspond one-to-one with the M slave transmitting devices;

Within the continuous isochronous intervals, the first broadcast data packet generated based on a target audio frame is a target first broadcast data packet, and the second broadcast data packet generated based on the target audio frame by a corresponding target slave transmitting device is a target second broadcast data packet. The target audio frame is any audio frame in the audio stream, the target slave transmitting device is any one of the M slave transmitting devices, and the audio data carried by the target first broadcast data packet is the same as the audio data carried by the target second broadcast data packet.

In other words, the first broadcast data packet and the second broadcast data packet that correspond to each other are generated based on the same audio frame in an audio stream to be transmitted, and the first broadcast data packet and the second broadcast data packet generated based on the same audio frame carry the same audio data.

In one embodiment, among the first broadcast data packet and/or at least one second broadcast data packet transmitted within the same isochronous interval, time slots occupied by any two different broadcast data packets are not overlapped with each other, and/or frequency domain channels occupied by any two different broadcast data packets are not overlapped with each other.

In one embodiment, the receiving module 1601 comprises: a determination unit configured to determine Q target communication link groups with the highest channel quality from the first communication link group and the M second communication link groups, wherein Q is a positive integer; and a receiving unit configured to receive at least one target broadcast data packet corresponding to the Q target communication link groups, wherein the target broadcast data packet is the first broadcast data packet or the second broadcast data packet.

In one embodiment, the determination unit is specifically configured to: determine the Q target communication link groups from the first communication link group and the M second communication link groups based on the communication performance of each communication link group. Q is a positive integer less than M+1, and the Q target communication link groups are the top Q communication link groups in the first communication link group and the M second communication link groups ranked by communication performance from high to low.

In one embodiment, the device 1600 further comprises an auxiliary synchronization module. The auxiliary synchronization module is specifically configured to: receive a joint auxiliary synchronization data packet transmitted by the master transmitting device based on a second advertising channel, wherein the joint auxiliary synchronization data packet comprises central link information of the first communication link group and M auxiliary link information for the M second communication link groups; and synchronize with the master transmitting device based on the joint auxiliary synchronization data packet.

In one embodiment, the central link information comprises P enable parameters, which have one-to-one correspondence with P auxiliary communication link groups. The parameter value of each enable parameter indicates whether the corresponding auxiliary communication link group is enabled. P is an integer greater than or equal to M, and the second communication link group is one enabled auxiliary communication link group.

The wireless audio data transmission device 1600 provided in this embodiment can implement each process of the wireless audio data transmission method on a receiving device side, and details are not repeated here to avoid redundancy.

Exemplarily, a structure of the master transmitting device, the slave transmitting device, or the candidate transmitting device may be as shown in FIG. 17, comprising an audio input unit, a user interface, an audio processing unit, a baseband data and protocol processor, and a BLE radio frequency transceiver module.

The audio input unit acquires digital audio signal and transmits them to the audio processing unit. Specifically, the audio input unit of the master transmitting device is a local audio memory, while the audio input unit of the slave transmitting device/candidate transmitting device is a BLE CIG wireless link.

The audio processing unit uses LC3 compression encoding for audio data.

The baseband data and protocol processor executes the JBIG link protocol and processes the audio data into BIS PDUs suitable for transmission by the BLE radio frequency transceiver module.

The BLE radio frequency transceiver module is used for transmitting and receiving BLE wireless signal or various PDUs, comprising PDUs for synchronization related to the JBIG link and PDUs related to the BPA link.

The BLE radio frequency transceiver module may also support future BLE high-rate physical layer technologies, such as 3 Mbps, 4 Mbps, 6 Mbps, and 7.5 Mbps.

The user interface, which may comprise buttons, touchscreens, etc., is used to acquire commands for controlling functions such as wireless audio transmission and JBIG link establishment.

The structure of the receiving device may also be as shown in FIG. 17, comprising a user interface, an audio output unit, an audio processing unit, a baseband data and protocol processor, and a BLE radio frequency transceiver module.

The baseband data and protocol processor executes the JBIG link protocol, processes BIS PDUs transmitted by the transmitting device and received by the BLE radio frequency transceiver module, and transmits them to the audio processing unit.

The audio processing unit is used for post-processing such as audio decoding, packet loss handling, equalization, and sound effects.

The audio output unit converts audio signal into sound signal.

The BLE radio frequency transceiver module is used for receiving BLE wireless signal or various PDUs, comprising advertising PDUs for synchronization related to the JBIG link.

The BLE radio frequency transceiver module may also support future BLE high-rate physical layer technologies, such as 3 Mbps, 4 Mbps, 6 Mbps, and 7.5 Mbps.

The user interface, which may comprise buttons, touchscreens, etc., is used to acquire commands for controlling wireless audio reception function.

According to one embodiment of the present disclosure, an electronic device and a readable storage medium are provided.

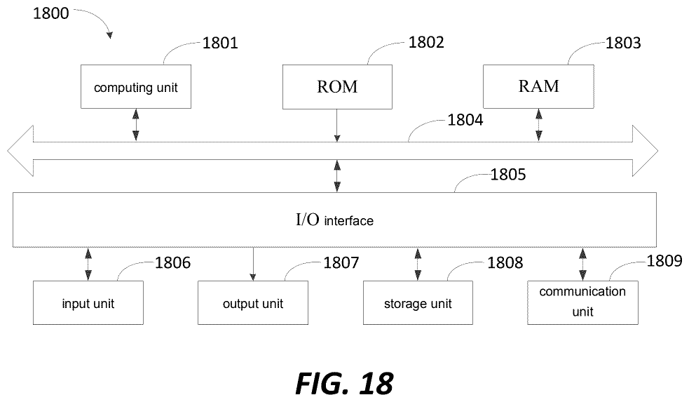

FIG. 18 shows a schematic block diagram of an example electronic device 1800 that can be used to implement the embodiments of the present disclosure. As shown in FIG. 18, the device 1800 comprises a computing unit 1801, which can execute various appropriate actions and processes based on computer programs stored in a Read-Only Memory (ROM) 1802 or loaded from a storage unit 1808 into a Random Access Memory (RAM) 1803. The RAM 1803 can also store various programs and data required for the operation of the device 1800. The computing unit 1801, the ROM 1802, and the RAM 1803 are interconnected via a bus 1804. An input/output (I/O) interface 1805 is also connected to the bus 1804.

Multiple components of the device 1800 are connected to the I/O interface 1805, including: an input unit 1806, such as a keyboard, mouse, etc.; an output unit 1807, such as various types of displays, speakers, etc.; a storage unit 1808, such as a magnetic disk, optical disk, etc.; and a communication unit 1809, such as a network card, a modem, a wireless communication transceiver, etc. The communication unit 1809 allows the device 1800 to exchange information/data with other devices via computer networks such as the Internet and/or various telecommunication networks.

The computing unit 1801 can be various general and/or special-purpose processing components with processing and computing capabilities. Examples of the computing unit 1801 comprise, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any suitable processor, controller, microcontroller, etc. The computing unit 1801 executes the various methods and processes described above, such as the wireless audio data transmission method. For example, in some embodiments, the wireless audio data transmission method can be implemented as a computer software program tangibly embodied in a machine-readable medium, such as the storage unit 1808. In some embodiments, part or all of the computer programs can be loaded and/or installed onto the device 1800 via the ROM 1802 and/or the communication unit 1809. When the computer program is loaded into the RAM 1803 and executed by the computing unit 1801, one or more steps of the wireless audio data transmission method described above can be performed. Alternatively, in other embodiments, the computing unit 1801 can be configured to execute the wireless audio data transmission method by any other suitable means (e.g., via firmware).

Besides point-to-multipoint Wireless Broadcast Audio (WBA) applications, there is also a need for multipoint-to-multipoint WBA applications, such as interactive multi-source wireless broadcast audio scenarios for teaching audio with teacher comments and explanations, and interactive multi-microphone wireless broadcast audio scenarios for multiple people speaking in turn. When the Broadcast Isochronous Group (BIG) link protocol is applied to interactive multi-source wireless broadcast audio scenarios, multiple existing BIG central devices operate independently and lack a synchronization mechanism. When these BIG central devices interactively switch to active BIG central devices, BIG peripheral devices need to re-synchronize with the active BIG central devices, which causes unsmooth playback of wireless broadcast audio.

The purpose of the present disclosure is to provide a wireless audio data transmission method, device, and system to solve the technical problem of unsmooth playback of wireless broadcast audio when related technologies are applied to interactive multi-source wireless broadcast audio scenarios.

A wireless audio data transmission method applied to a master central device is provided according to one embodiment of the present disclosure. The wireless audio data transmission method comprises: transmitting a first broadcast data packet to N peripheral devices via a first communication link group; or exchanging control commands with a target slave transmitting device via a bidirectional link to suspend the first communication link group, such that the target slave central device establishes a second communication link group and transmits a corresponding second broadcast data packet to the N peripheral devices via the second communication link group.

The target slave central device is one of M slave central devices that are clock-synchronized with the master central device. The first communication link group and the second communication link group are constructed based on the same link information, where N and M are positive integers.

The master central device may also be referred to as a master transmitting device, the slave central device may also be referred to as a slave transmitting device, and the peripheral devices may also be referred to as receiving devices.

The first communication link group and the second communication link group may be any link groups supporting broadcast communication, for example, a Broadcast Isochronous Group (BIG) link group.

In this disclosure, by coordinating the master central device and multiple slave central devices to perform alternating broadcasting to multiple peripheral devices, the demand for multipoint-to-multipoint WBA applications is satisfied. The first communication link group of the master central device and the second communication link group of the slave central device are constructed based on the same link information to achieve link information reuse. This avoids the time consumption caused by the peripheral devices having to resynchronize link information during link group switching, thereby enabling smoother playback of wireless broadcast audio in interactive multi-source wireless broadcast audio scenario.

The audio stream used to form the first broadcast data packet and the audio stream used to form the second broadcast data packet may be different. Additionally, the audio stream used to form the second broadcast data packet of a first slave central device and the audio stream used to form the second broadcast data packets of a second slave central device may also be different, where the first slave central device and the second slave central device are any two different devices among the M slave central devices.

It should be understood that once the first communication link group is established, it continues to exist and can switch between an active state and a paused state. When the first communication link group is active, the master central device transmits the first broadcast data packet to the N peripheral devices via the first communication link group. When the first communication link group is paused, the slave central device can reuse the link information of the first communication link group to construct a second communication link group and transmit the corresponding second broadcast data packet to the N peripheral devices via the constructed second communication link group.

When the first communication link group is paused, the target slave central device authorized by the master central device constructs a new second communication link group by reusing the link information of the first communication link group (i.e., the second communication link group occupies the same time slots and frequency channels as the first communication link group) and transmits the corresponding second broadcast data packet to the N peripheral devices via the constructed second communication link group. After the second broadcast data packet is transmitted, the second communication link group is disconnected, and the first communication link group switches back from the paused state to the active state.

Exemplarily, the peripheral devices and the slave central devices complete synchronization with the master central device by sequentially receiving an Extended Advertisement (ADV_EXT_IND) PDU transmitted by the master central device on a Primary Advertising channel, an Auxiliary Advertisement (AUX_ADV_IND) PDU transmitted on a Secondary Advertising channel, and an Auxiliary Synchronization (AUX_SYNC_IND) PDU transmitted on a Periodic Advertising channel. The auxiliary synchronization data packet (AUX_SYNC_IND PDU) carries target link information, and both the first communication link group and the second communication link group are constructed using this target link information.

Since the clocks of the master central device and the slave central devices are independent, there will be relative deviations or drifts. Therefore, after the slave central device synchronizes with the master central device and establishes the second communication link group, it needs to continuously receive the auxiliary synchronization data packet transmitted by the master central device on the periodic advertising channel to adjust its clock and maintain clock consistency with the master central device. This ensures that the timing of the auxiliary synchronization data packet transmitted by the master central device and the second broadcast data packets transmitted by the slave central device remains relatively unchanged. As a result, the peripheral devices can normally receive the second broadcast data packets from the slave central device using the target link information provided by the AUX_SYNC_IND PDU, or switch between the first communication link group and the second communication link group without re-synchronization.

In one embodiment, the exchanging control commands with a target slave transmitting device via a bidirectional link comprises: transmitting an Access Permit command to the target slave central device via the bidirectional link; receiving an access response command fed back by the target slave central device via the bidirectional link.

Further, before the exchanging control commands with a target slave transmitting device via a bidirectional link, the method further comprises: transmitting a random access command to the M slave central devices via the bidirectional link; receiving, via the bidirectional link, an access request command transmitted by each of at least one slave central devices, and determining the target slave central device from the at least one slave central devices.

The random access command comprises a first data indicating a deadline for random access.

The access request command comprises a second data indicating the device address of the corresponding slave central device.

The Access Permit command comprises a third data indicating the device address of the target slave central device and a fourth data indicating an effective time of the second communication link group.

The access response command comprises a fifth data indicating the device address of the target slave central device.

In this embodiment, by defining the access permission command, the access response command, the random access command, the access request command, and a transmitting/receiving flow between these commands, control command interaction between the master central device and slave central devices and the selection of the target sub-center device by the master control central device are achieved.

The bidirectional link may be a point-to-multipoint bidirectional link, such as a bidirectional periodic advertising link, or other links like a bidirectional broadcast control link or an Asynchronous Connection-oriented (ACL) link.

After the master central device transmits the random access command to the M slave central devices, a random access window is opened. Before a random access deadline, each of M slave central devices may transmit a corresponding access request command to the master central device, in order to request the master central device for establishing the corresponding second communication link group and transmitting the corresponding second broadcast data packet.

It should be understood that the M slave central devices are only allowed to transmit corresponding access request commands to the master central device within the random access window opened by the master central device. At other times, such transmission is not permitted.

After the master central device determines the target slave central device from at least one of the slave central devices, the master central device may choose to close the random access window in advance or maintain the random access window while discarding any access request commands received after the target slave central device is selected.

Once the target slave central device is determined, the master central device may transmit an Access Permit command to the selected target slave central device, prompting the target slave central device to feedback an access response command based on the Access Permit command and establish a new second communication link group.

It should be noted that the rule for selecting the target slave central device from the M slave central devices by the master control central device can be adaptively configured according to actual requirements. For example: different device priorities may be set for the M slave central devices, and the master control central device may, during the random access window, determine the access request command corresponding to the highest device priority among the received at least one access request command as the target access request command, and accordingly identify the slave central device associated with the target access request command as the target slave central device.

Alternatively, the master central device may be configured to designate the slave central device corresponding to the access request command received first within the random access window as the target slave central device.

The aforementioned effective time is used to determine the start time when the target slave central device is allowed to establish the second communication link group. The fourth data indicating the effective time of the second communication link group is set to reserve time for pausing the first communication link group, establishing the second communication link group, and feedback of commands from the target slave central device. This ensures a stable switch from the first communication link group to the second communication link group. The effective time is set by the master central device, so that the time conflict problem caused by equipment information synchronization obstacles among different slave central device can be avoided.

In one embodiment, an access termination command is transmitted to the target slave central device via the bidirectional link, such that the second communication link is disconnected after the access termination command takes effect.

In another embodiment, an access termination command transmitted by the target slave central device is received via the bidirectional link, such that the second communication link is disconnected after the access termination command takes effect.

By allowing the target slave central device to actively initiate the access termination command and passively receive the access termination command from the master central device, flexible disconnection of the second communication link group established by the target slave central device is achieved.

In one example, the link group for transmitting audio data between the peripheral devices and the central devices (comprising the master central device and the slave central device) may be defined as an Interactive Broadcast Isochronous Group (IBIG) link group. With reference to the BLE protocol, the aforementioned control commands (i.e., the random access command, the access request command, the access permission command, the access response command, and the access termination command) are defined as follows: the random access command is “IBIG Random Access,” the access request command is “IBIG Access Request,” the Access Permit command is “IBIG Access Permit,” the access response command is “IBIG Access Response,” and the access termination command is “IBIG Access Terminate.”

The random access command, the access permission command, and the access termination command may be carried in the Advertisement Data (Adv Data) field of the auxiliary synchronization data packet transmitted by the master central device over the bidirectional link. The access request command, the access response command, and the access termination command may be carried in the Adv Data field of the auxiliary synchronization reverse control packets (AUX_SYNC_RC PDU) transmitted by the slave central device over the bidirectional link.

The link through which the master central device and the slave central devices transmit and receive the AUX_SYNC_IND PDU and the AUX_SYNC_RC PDU carrying the random access command, the access request command, the access permission command, the access response command, and the access termination command on the Periodic Advertising channel may be referred to as a Bidirectional Periodic Advertising (BPA) link.

The AUX_SYNC_RC PDU, similar to the AUX_SYNC_IND PDU defined in the BLE protocol, uses the Common Extended Advertising Payload Format specified in the BLE specification. The differences are that the AUX_SYNC_IND PDU comprises an Additional Controller Advertising Data (ACAD) field carrying BIGInfo (which can be understood as the aforementioned target link information), while the AUX_SYNC_RC PDU does not comprise the ACAD field, and the content of Adv Data differs between them. Both AUX_SYNC_IND PDU and AUX_SYNC_RC PDU carry the control command (Control Command) through their Adv Data fields.

The format of the control command comprises two parts: an operation code (Opcode) and control data (CtrData). The Opcode and CtrData differ for different control commands.

IBIG Random Access is used by the master central device to open a random access window, facilitating the slave central devices to transmit the IBIG Access Request for access. The slave central devices are only permitted to transmit the IBIG Access Request within the random access window opened by the master central device. At other times, such transmission is not allowed.

IBIG Access Request is used by the slave central devices to request access to the IBIG link group and establish the second communication link group when the master central device opens the random access window. IBIG Access Permit is used by the master central device to authorize the slave central device to access the IBIG link group and establish the second communication link group. IBIG Terminate is used by the master central device to terminate the second communication link group corresponding to the slave central device, and may also be used by the slave central device to request termination of its corresponding second communication link group.

Exemplarily, the Opcode for IBIG Random Access may be set as 0x80, the Opcode for IBIG Access Request may be set as 0x81, the Opcode for IBIG Access Permit may be set as 0x82, the Opcode for IBIG Access Response may be set as 0x83, and the Opcode for IBIG Terminate may be set as 0x84.

The CtrData of IBIG Random Access comprises a 2-byte random access deadline (Deadline). The unit of the deadline is one Periodic Advertising Interval (PA Interval), i.e., the interval for transmitting AUX_SYNC_IND PDUs. The value of the deadline indicates the number of PA Intervals. The aforementioned first data corresponds to the Deadline field.

The deadline defines an access window consisting of Deadline number of PA Intervals starting from the transmission of the AUX_SYNC_IND PDU carrying the IBIG Random Access command. Within this access window, the slave central devices are allowed to transmit the IBIG Access Request command via AUX_SYNC_RC PDU.

Upon receiving the IBIG Random Access command, the slave central device will randomly delay for a certain time before re-receiving the IBIG Random Access command and sending the IBIG Access Request, in order to avoid collisions with IBIG Access Request commands sent by other slave central devices. The random delay time is an integer multiple of the PA Interval and does not exceed the Deadline. When the Deadline is 0xFFFF, it represents an infinite deadline.

The CtrData of the IBIG Access Request command and the IBIG Access Response command comprises a 6-byte device address (Device Address). The aforementioned second data and the fifth data both correspond to the Device Address field.

In the IBIG Access Request command, the Device Address is the address of the slave central device requesting access to the IBIG link group to establish the SBIG. In IBIG Access Response command, the Device Address is the address of the target slave central device confirmed by the master central device to access the IBIG link group and establish the second communication link group.

It should be noted that although the CtrData of IBIG Access Request command and the IBIG Access Response command are the same, their Opcodes differ.

The CtrData of the IBIG Access Permit command comprises a 6-byte device address (Device Address) and a 2-byte effective time (Instant). The aforementioned third data corresponds to the Device Address field, and the fourth data corresponds to the Instant field.

The Device Address is the address of the target slave central device permitted to access the IBIG link group and establish the second communication link group.

The Instant represents the effective time of the IBIG Access Permit command, with its unit being one Periodic Advertising Interval (PA Interval). The value of Instant indicates the number of PA Intervals. Specifically, the effective time means the IBIG Access Permit command takes effect after Instant number of PA Intervals from the transmission of the AUX_SYNC_IND PDU carrying the IBIG Access Permit command.

The CtrData of the IBIG Terminate command comprises a 1-byte Reason, a 6-byte Device Address, and a 2-byte Instant.

The Device Address is the address of the target slave central device from which the second communication link group is to be disconnected.

The Reason indicates the Reason for terminating the second communication link group.

The Instant is the effective time of the IBIG Terminate command, defined similarly to the Instant of the IBIG Access Permit command.

Exemplarily, the Reason for disconnecting the SBIG link may comprise five types: 0x01 indicates that the master central device disconnects the second communication link group to restore the first communication link group.

0x02 indicates that the master central device disconnects the currently established the second communication link group to allow another slave central device to establish a new second communication link group.

0x03 indicates that the target slave central device actively disconnects its corresponding second communication link group.

0x04 indicates that the target slave central device disconnects its corresponding second communication link group due to abnormal reasons such as insufficient power.

0x05 indicates that the target slave central device disconnects its corresponding second communication link group due to shut down.

The process by which the master central device assists the slave central device in establishing the corresponding second communication link group is as follows.

After the master central device automatically or through a user interface (UI) enters the multi-source interactive mode, it transmits an AUX_SYNC_IND PDU carrying the IBIG Random Access command on the periodic advertising channel and receives an AUX_SYNC_RC PDU carrying the IBIG Access Request command replied by the slave central device with an interval of T_IFS (Time of Inter Frame Space). According to the BLE protocol, T_IFS is 150 μs or another value defined by future BLE protocols.

Upon receiving the IBIG Access Request command from the slave central device: if the master central device does not permit establishing the second communication link group, it continues to transmit the IBIG Random Access command and receives the IBIG Access Request commands from other slave central devices; If permitted, the master central device transmits an IBIG Access Permit command to the target slave central device with a specified device address and receives an IBIG Access Response command replied by the target slave central device with an interval of T_IFS.

After confirming receipt of the IBIG Access Response command, the master central device pauses the first communication link group after the effective time of the IBIG Access Permit command. Once the master central device stops the first communication link group, the target slave central device establishes the second communication link group.

If the master central device does not receive the IBIG Access Response command, it continuously transmits the IBIG Access Permit command and waits for the IBIG Access Response command from the target slave central device until a timeout occurs. After the timeout, it resumes transmitting the IBIG Random Access command.

The process by which a slave central device establishes the second communication link group is as follows.

After the slave central device automatically or through a UI enters the multi-source interactive mode, it first sequentially receives the ADV_EXT_IND PDU, AUX_ADV_IND PDU, and the AUX_SYNC_IND PDU to synchronize with the master central device.

After synchronization, the slave central device randomly delays for several PA Intervals, then receives the IBIG Random Access command from the master central device and replies with an AUX_SYNC_RC PDU carrying the IBIG Access Request command with an interval of T_IFD.

Subsequently, it receives the IBIG Access Permit command from the master central device: if the IBIG Access Permit command is not received and a timeout occurs, it re-receives the IBIG Random Access command. If the IBIG Access Permit command is received, it replies with an IBIG Access Response command with an interval of T_IFS, establishes the second communication link group after the effective time of the IBIG Access Permit command, and transmits the second broadcast data packet carrying audio data via the second communication link group.

If the master central device intends to stop the second communication link group, it sends an IBIG Terminate command to the target slave central device with the reason for disconnection, and the second communication link group is disconnected after the IBIG Terminate command takes effect.

If the target slave central device intends to disconnect the second communication link group, it sends an IBIG Terminate command to the master central device with the reason for disconnection, and the second communication link group is disconnected after the IBIG Terminate command takes effect.

In one embodiment, when the master central device and the slave central devices need to alternately broadcast audio data, they alternately establish and disconnect the second communication link group, as well as disconnect the second communication link group and restore the first communication link group.

A multipoint-to-multipoint wireless broadcast audio solution described in this disclosure may be referred to as Interactive Multi-Source Wireless Broadcast Audio (IMS-WBA), which supports multipoint-to-multipoint interactive audio broadcast requirements. For example, it can be applied to interactive multi-source wireless broadcast audio scenarios involving teaching audio with teacher comments and explanations, as well as interactive multi-microphone wireless broadcast audio scenarios where multiple people speak in turn.

An IMS-WBA system comprises one master central device, at least one slave central device, and at least one peripheral device.

For ease of understanding, an example is described as follows:

In an interactive multi-source wireless broadcast audio scenario involving teaching audio with teacher comments and explanations, the IMS-WBA system comprises a teaching audio-visual device, a wireless microphone, and multiple wireless headphones or distributed wireless speakers. The teaching audio-visual device acts as the master central device, the wireless microphone acts as the slave central device, and the multiple wireless headphones or distributed wireless speakers act as the IBIG peripheral devices.

Audio broadcasting between the teaching audio-visual device and the wireless headphones/distributed wireless speakers is carried out via the first communication link group, while audio broadcasting between the wireless microphone and the wireless headphones/distributed wireless speakers is carried out via the second communication link group.

The IBIG links between the IBIG central devices (comprising the teaching audio-visual device and the wireless microphone) and the IBIG peripheral devices consist of a Primary BIG (PBIG) link (which can be understood as the first communication link group) and a Secondary BIG (SBIG) link (which can be understood as the second communication link group).

During the broadcast of teaching audio by the teaching audio-visual device, the teacher can provide comments or explanations at any time. The teaching audio-visual device broadcasts teaching audio via the PBIG link, and the wireless microphone broadcasts teacher comments/explanations via the SBIG link. When the teacher uses the SBIG link for comments/explanations, the PBIG link pauses transmitting teaching audio; after the comments/explanations end, the PBIG link resumes transmitting teaching audio.

Key parameters of the IBIG link include: for the teaching audio-visual device: stereo digital audio with a 48 KHz sampling rate uses the Low Complexity Communication Codec (LC3) with a frame length of 10 ms, a coding rate of 96 kbps, a Service Data Unit (SDU) size of 120 bytes, an IBIS isochronous interval (ISO Interval) of 10 ms, 2 BIS links, a Number of Sub-Event (NSE) of 5, a Burst Number (BN) of 1, an Immediate Repetition Count (IRC) of 4, and a Pre-Transmission Offset (PTO) value of 1. The payload size of the IBIS PDU is 120 bytes, containing one SDU. Transmission employs the BLE 2 Mbps physical layer. The periodic advertising interval is 30 ms, the offset between the start of periodic advertising and the start of IBIG (IBIG Offset) is 1.23 ms, and the interval or airtime slot occupied by each IBIS PDU is 700 μs. These basic details are included in the IBIG Info. The PBIG and SBIG links share identical link information.

For the wireless microphone: mono digital audio with a 48 KHz sampling rate uses LC3 coding with a frame length of 10 ms, a coding rate of 96 kbps, and an SDU size of 120 bytes. Since the SBIG link information is the same as the PBIG link information, when switching from PBIG to SBIG, the mono audio data from the wireless microphone is replicated into stereo audio data and transmitted via the SBIG link using the same link information as PBIG.

Through the IBIG links, the wireless headphones or the distributed wireless speakers can interactively receive and play the wireless broadcast audio from both the teaching audio-visual device and the wireless microphone without requiring re-synchronization.

In summary, the solutions of this application eliminate the need for multiple peripheral devices to repeatedly synchronize link information with different central devices when alternately receiving broadcast audio data. This ensures smooth broadcast transmission between different central devices and the multiple peripheral devices. Additionally, the solution is compatible with the BLE Audio BIG peripheral devices (the standard BLE Audio BIG peripheral devices) can synchronize with the master central device described herein, receive the broadcast data packets from both the master and slave central devices, and seamlessly switch between the first and second communication link groups without re-synchronization.

In one embodiment, the present disclosure also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, etc.

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present disclosure have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various modifications and variations to the disclosure without departing from the spirit and scope. Accordingly, all such modifications and alterations that fall within the scope of the appended claims and their equivalents are intended to be encompassed by this disclosure.

What is claimed is:

1. A wireless audio data transmission method, applied to a transmitting device group comprising a master transmitting device and one or more slave transmitting devices synchronized with the master transmitting device, the method comprising:
transmitting, by the master transmitting device, a first broadcast packet to one or more receiving devices based on a first communication link group, and/or transmitting, by at least one of the one or more slave transmitting devices, a second broadcast packet to the one or more receiving devices based on a corresponding second communication link group within one of multiple continuous isochronous intervals;
wherein the first broadcast data packet and the second broadcast data packet that correspond to each other are generated based on a same audio frame in an audio stream to be transmitted, and the first broadcast data packet and the second broadcast data packet generated based on the same audio frame carry a same audio data.

2. The method according to claim 1, further comprising:
transmitting, by the master transmitting device, a synchronized joint access data packet via a first advertising channel and receiving, by the master transmitting device, a synchronized joint request data packet carrying request link information fed back by a candidate transmitting device in response to the synchronized joint access data packet, the request link information comprising a device address and/or a device identifier of the candidate transmitting device;
transmitting, by the master transmitting device, a synchronized joint configuration data packet carrying configuration link information to the candidate transmitting device when the master transmitting device determines that the candidate transmitting device is permitted to join the transmitting device group based on the device address and/or the device identifier; and
receiving, by the master transmitting device, a synchronized joint response data packet fed back by the candidate transmitting device in response to the synchronized joint configuration data packet and designating the candidate transmitting device as one slave transmitting device, wherein the candidate transmitting device is configured to establish corresponding second communication link group based on the configuration link information;
wherein in the first broadcast data packet and/or at least one second broadcast data packet transmitted in the same isochronous interval, time slots occupied by any two different broadcast data packets are not overlapped with each other, and/or frequency domain channels occupied by any two different broadcast data packets are not overlapped with each other.

3. The method according to claim 1, further comprising:
transmitting, by the master transmitting device, a joint auxiliary synchronization data packet via a second advertising channel, wherein the joint auxiliary synchronization data packet comprises central link information of the first communication link group and auxiliary link information of each second communication link group, the joint auxiliary synchronization data packet is used for the receiving devices to synchronize with the master transmitting device, receive the first broadcast data packet based on the first communication link group, and receive the corresponding second broadcast data packet based on each second communication link group.

4. The method according to claim 3, wherein the central link information comprises P enable parameters, wherein the P enable parameters are in one-to-one correspondence with P auxiliary communication link groups; a parameter value of each enable parameter is used to indicate whether the corresponding auxiliary communication link group is enabled; P is an integer greater than or equal to 1; and each second communication link group is one enabled auxiliary communication link group,
wherein the joint auxiliary synchronization data packet is a data packet in a common extended advertising payload format, an extended header of the joint auxiliary synchronization data packet carries the central link information, and the P enable parameters occupy part or all of bits in a reserved field of the central link information.

5. The method according to claim 1, wherein the continuous isochronous intervals comprise a first isochronous interval and a second isochronous interval, which are any two different isochronous intervals among the continuous isochronous intervals;
a time slot position occupied by the first broadcast data packet in the first isochronous interval is identical to a time slot position occupied by the first broadcast data packet in the second isochronous interval; and
a time slot position occupied by the second broadcast data packet in the first isochronous interval is identical to a time slot position occupied by the second broadcast data packet in the second isochronous interval.

6. The method according to claim 1, wherein each slave transmitting device adjusts its clock based on a target data packet transmitted by the master transmitting device, so that the slave transmitting device is synchronized with the master transmitting device;
wherein the target data packet is a data packet transmitted by the master transmitting device based on a first advertising channel, and/or a data packet transmitted by the master transmitting device based on a second advertising channel;
the first advertising channel is a channel used for determining the slave transmitting device, and the second advertising channel is a channel used for the receiving device to synchronize with the master transmitting device.

7. A wireless audio data transmission method applied to a master transmitting device, the method comprising:
transmitting a joint auxiliary synchronization data packet to one or more receiving devices via a second advertising channel so that the one or more receiving devices can synchronize with the master transmitting device, receive a first broadcast data packet transmitted by the master transmitting device via a first communication link group, and/or receive a second broadcast data packet transmitted by corresponding slave transmitting device via at least one second communication link group when the master transmitting device is clock-synchronized with one or more slave transmitting devices;
wherein the first broadcast data packet and the second broadcast data packet that correspond to each other are generated based on a same audio frame in an audio stream to be transmitted, and the first broadcast data packet and the second broadcast data packet generated based on the same audio frame carry a same audio data.

8. The method according to claim 7, further comprising:
transmitting a synchronized joint access data packet via a first advertising channel and receiving a synchronized joint request data packet carrying request link information fed back by a candidate transmitting device in response to the synchronized joint access data packet, the request link information comprising a device address and/or a device identifier of the candidate transmitting device;
transmitting a synchronized joint configuration data packet carrying configuration link information to the candidate transmitting device when the master transmitting device determines that the candidate transmitting device is permitted to join the transmitting device group based on the device address and/or the device identifier; and
receiving a synchronized joint response data packet fed back by the candidate transmitting device in response to the synchronized joint configuration data packet and designating the candidate transmitting device as one slave transmitting device, wherein the candidate transmitting device is configured to establish corresponding second communication link group based on the configuration link information;
wherein in the first broadcast data packet and/or at least one second broadcast data packet transmitted in the same isochronous interval, time slots occupied by any two different broadcast data packets are not overlapped with each other, and/or frequency domain channels occupied by any two different broadcast data packets are not overlapped with each other.

9. The method according to claim 7, wherein the joint auxiliary synchronization data packet comprises central link information of the first communication link group, and the first communication link group is a communication link group for transmitting the first broadcast data packet;
the joint auxiliary synchronization data packet comprises one or more auxiliary link information corresponding to the one or more second communication link groups, the second communication link is a communication link group for transmitting the second broadcast data packet;
the central link information comprises P enable parameters, wherein the P enable parameters are in one-to-one correspondence with P auxiliary communication link groups; a parameter value of each enable parameter is used to indicate whether the corresponding auxiliary communication link group is enabled; P is an integer greater than or equal to 1; and each second communication link group is one enabled auxiliary communication link group,
wherein the joint auxiliary synchronization data packet is a data packet in a common extended advertising payload format; an extended header of the joint auxiliary synchronization data packet carries the central link information; and the P enable parameters occupy part or all of bits in a reserved field of the central link information.

10. The method according to claim 7, wherein the continuous isochronous intervals comprise a first isochronous interval and a second isochronous interval, which are any two different isochronous intervals among the continuous isochronous intervals;
a time slot position occupied by the first broadcast data packet in the first isochronous interval is identical to a time slot position occupied by the first broadcast data packet in the second isochronous interval;
a time slot position occupied by the second broadcast data packet in the first isochronous interval is identical to a time slot position occupied by the second broadcast data packet in the second isochronous interval.

11. The method according to claim 7, further comprising:
transmitting a target data packet to the slave transmitting device so that the slave transmitting device adjusts its clock based on the target data packet to synchronize its clock with the clock of the master transmitting device;
the target data packet is transmitted by the master transmitting device via the first advertising channel and/or the second advertising channel;
the first advertising channel is a channel used for determining the slave transmitting device, and the second advertising channel is a channel used for the receiving device to synchronize with the master transmitting device.

12. A wireless audio data transmission method applied to a candidate transmitting device, the method comprising:
jointing with a master transmitting device via a bidirectional periodic advertising link and establishing a second communication link group for communication with one or more receiving devices, wherein the master transmitting device is configured to transmits a first broadcast data packet to the one or more receiving devices via a first communication link group;
transmitting a second broadcast data packet to the one or more receiving devices via the second communication link group;
wherein the first broadcast data packet and the second broadcast data packet that correspond to each other are generated based on a same audio frame in an audio stream to be transmitted, and the first broadcast data packet and the second broadcast data packet generated based on the same audio frame carry a same audio data.

13. The method according to claim 12, wherein the transmitting a second broadcast data packet to the one or more receiving devices via the second communication link group comprises:
processing an audio frame of an audio stream based on predefined encapsulation parameter information to generate the second broadcast data packet;
transmitting the second broadcast data packet to the one or more receiving devices via the second communication link group;
wherein the first broadcast data packet is generated by processing the audio frame of the audio stream based on the same predefined encapsulation parameter information;
in the first broadcast data packet and/or at least one second broadcast data packet transmitted in the same isochronous interval, time slots occupied by any two different broadcast data packets are not overlapped with each other, and/or frequency domain channels occupied by any two different broadcast data packets are not overlapped with each other.

14. The method according to claim 12, wherein the jointing with a master transmitting device via a bidirectional periodic advertising link and establishing a second communication link group for communication with one or more receiving devices comprises:
receiving a synchronized joint access data packet transmitted by the master transmitting device via the bidirectional periodic advertising link;
transmitting a synchronized joint request data packet carrying request link information comprising a device address and/or a device identifier of the candidate transmitting device to the master transmitting device via the bidirectional periodic advertising link in response to the synchronized joint access data packet;
receiving a synchronized joint configuration data packet carrying configuration link information transmitted by the master transmitting device via the bidirectional periodic advertising link when the master transmitting device determines that the candidate transmitting device is permitted to joint with the master transmitting device based on the device address and/or the device identifier;
transmitting a synchronized joint response data packet to the master transmitting device via the bidirectional periodic advertising link, thereby designating the candidate transmitting device as the slave transmitting device jointing with the master transmitting device, and establishing the second communication link group based on the configuration link information.

15. A wireless audio data transmission system, comprising:
a transmitting device group comprising a master transmitting device and one or more slave transmitting devices synchronized with the master transmitting device; and
one or more receiving devices;
wherein the master transmitting device transmits a first broadcast packet to the receiving devices based on a first communication link group, and/or at least one of the one or more slave transmitting devices transmits a second broadcast packet to the receiving devices based on a second communication link group within one of multiple continuous isochronous intervals;
wherein the first broadcast data packet and the second broadcast data packet that correspond to each other are generated based on a same audio frame in an audio stream to be transmitted, and the first broadcast data packet and the second broadcast data packet generated based on the same audio frame carry a same audio data.

16. The system according to claim 15, wherein the master transmitting device is further configured for:
transmitting a synchronized joint access data packet via a first advertising channel and receiving, by the master transmitting device, a synchronized joint request data packet carrying request link information fed back by a candidate transmitting device in response to the synchronized joint access data packet, the request link information comprising a device address and/or a device identifier of the candidate transmitting device;
transmitting a synchronized joint configuration data packet carrying configuration link information to the candidate transmitting device when the master transmitting device determines that the candidate transmitting device is permitted to join the transmitting device group based on the device address and/or the device identifier;
receiving a synchronized joint response data packet fed back by the candidate transmitting device in response to the synchronized joint configuration data packet and designating the candidate transmitting device as one slave transmitting device, wherein the candidate transmitting device is configured to establish corresponding second communication link group based on the configuration link information;
wherein in the first broadcast data packet and/or at least one second broadcast data packet transmitted in the same isochronous interval, time slots occupied by any two different broadcast data packets are not overlapped with each other, and/or frequency domain channels occupied by any two different broadcast data packets are not overlapped with each other.

17. A wireless audio data transmission method, applied to a master transmitting device, the method comprising:
transmitting a first broadcast data packet to one or more receiving devices based on a first communication link group; and
exchanging control commands with a target slave transmitting device via a bidirectional link to suspend the first communication link group, such that the target slave transmitting device establishes a second communication link group and transmits a corresponding second broadcast data packet to the one or more receiving devices based on the second communication link group;
wherein the target slave transmitting device is one of one or more slave transmitting devices that are clock-synchronized with the master transmitting device, and the first communication link group and the second communication link group are formed based on same link information.

18. The method of claim 17, wherein the exchanging control commands with a target slave transmitting device through a bidirectional link comprises:
transmitting an Access Permit command to the target slave transmitting device via the bidirectional link; and
receiving an access response command fed back by the target slave transmitting device via the bidirectional link.

19. The method of claim 18, wherein before the exchanging control commands with a target slave transmitting device through a bidirectional link, the method further comprises:
transmitting a random access command to the one or more slave transmitting devices via the bidirectional link;
receiving an access request command transmitted by each of at least one slave transmitting device via the bidirectional link, and determining the target slave transmitting device from the at least one slave transmitting device.

20. The method of claim 17, further comprising:
transmitting an access termination command to the target slave transmitting device via the bidirectional link, such that the second communication link is disconnected after the access termination command takes effect; or,
receiving an access termination command transmitted by the target slave transmitting device via the bidirectional link, such that the second communication link is disconnected after the access termination command takes effect.
